(19) United States
(12) Patent Application Publication
(10) Pub. No.: US 2026/0156649 A1
(43) Pub. Date: Jun. 4, 2026

(54) TRANSPORT BLOCK TRANSMISSION METHOD AND DEVICE

(71) Applicant: LG ELECTRONICS INC., Seoul (KR)

(72) Inventors: Jongku LEE, Seoul (KR); Kijun KIM, Seoul (KR); Dongsun LEE, Seoul (KR)

(73) Assignee: LG ELECTRONICS INC., Seoul (KR)

(21) Appl. No.: 19/123,583

(22) PCT Filed: Oct. 31, 2022
(86) PCT No.: PCT/KR2022/016822

§ 371 Date: Apr. 23, 2025

(51) Int. Cl. H04L 5/00; H04W 72/0446

(52) U.S. Cl. CPC H04W 72/23; H04L 1/0003; H04L 1/0014; H04L 5/0048

(57) ABSTRACT

A method of transmitting a transport block by a device in a wireless communication system and a device using the method are provided. The method generates multiple pieces of data and generates multiple MAC PDUs each including at least one of the multiple pieces of data. The multiple MAC PDUs have different logical channel priorities (importance levels) and one MAC PDU is transmitted using one transport block. Multiple transport blocks comprise a first transport block including a MAC PDU having a high logical channel priority and a second transport block including a MAC PDU having a low logical channel priority. The first transport block always comprises one code block, and the second transport block comprises one or multiple code blocks.

### CROSS-REFERENCE TO RELATED APPLICATION(S)

This application is the National Stage filing under 35 U.S.C. 371 of International Application No. PCT/KR2022/016822, filed on Oct. 31, 2022, the contents of which is hereby incorporated by reference herein in its entirety.

### TECHNICAL FIELD

The present specification relates to a method and device for transmitting and receiving a transport block in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a user equipment (UE) as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc.

In NR, when transmitting first data (e.g., signaling data) with relatively high priority (importance) together with second data (e.g., user data or application data) with relatively low priority (importance), a transmission device and method are needed to efficiently ensure transmission quality of the first data. The first data may mean control information, such as MAC CE (Control Element), for example. The second data may mean traffic data, such as user data or application data.

MAC CE transmits control information in the MAC layer. Base stations and UEs can transmit control information faster than higher layer signaling such as RRC using MAC CE. MAC CE can carry more and different control information compared to physical layer signaling, such as downlink control information (DCI).

As the need to provide increasingly diverse functions with lower delay values in wireless communication systems increases, the need for base stations and UEs to quickly exchange various types of control information also increases. Accordingly, the use and importance of MAC CE are also increasing, and this trend is expected to continue in next-generation wireless communication systems such as 6G.

In the prior art, MAC CE is transmitted along with traffic data in a MAC PDU. One MAC PDU is transmitted through one Transport Block (TB) in the physical layer. One MCS (Modulation and Coding Scheme) is applied to one Transport Block and transmitted, so that MAC CE and traffic data in the physical layer have the same transmission quality.

That is, in the conventional technology, two pieces of information with different priorities, that is, first data (e.g., MAC CE) and second data (e.g., traffic data), are structured to be transmitted with the same transmission quality. Since MAC CE transmits control information, if an error occurs in a transport block including MAC CE, the operations of the base station and UE may be delayed, which may lead to a decrease in system performance, such as a decrease in data transmission speed or an increase in transmission delay.

In order to reduce transmission errors in transport blocks including MAC CEs, a method of lowering the MCS of the transport blocks can be considered. However, since the MAC CE generally occupies a small portion of a transport block, lowering the MCS to increase the transmission reliability of MAC CEs can result in data other than MAC CEs, which occupy most of the transport block, being transmitted at a low MCS, which can reduce the efficiency of radio resource use.

### SUMMARY

A method and device for transmitting a transport block capable of solving the above-mentioned problem are needed.

In another aspect, a method for transmitting a transport block of a device in a wireless communication system and a device using the method are provided. The method comprises generating a media access control element (MAC CE) and traffic data, generating MAC PDUs including at least one of the MAC CE and the traffic data, and transmitting the MAC PDUs through a plurality of transport blocks. Here, the plurality of transport blocks include a first transport block including the MAC CE and a second transport block not including the MAC CE but including the traffic data. Additionally, the first transport block always includes one code block, and the second transport block includes one or more code blocks.

In another aspect, a UE and a processing device implementing the above method, a computer readable medium (CRM) are provided.

In another aspect, a method performed by a base station is provided. The method comprises receiving a media access control (MAC) control element (CE) and traffic data via a plurality of transport blocks, and decoding the MAC CE and the traffic data. Here the plurality of transport blocks include a first transport block including the MAC CE and a second transport block not including the MAC CE but including the traffic data. The first transport block always includes one code block (CB), and the second transport block includes one or more code blocks.

In another aspect, a base station implementing the above method is provided.

The present disclosure can have various effects.

When transmitting MAC CE (or a small amount of specific data that requires high transmission reliability) together with a large amount of data that requires relatively low transmission reliability, it is possible to transmit the two data groups by applying different MCSs.

Through this, the transmission reliability of MAC CE can be increased, thereby improving the stability and performance of the system, while at the same time maintaining the efficiency of resource use when transmitting large amounts of data.

In addition, when notifying the different MCSs through DCI, the increase in the number of bits of DCI can be minimized.

Advantageous effects which can be obtained through specific embodiments of the present specification are not limited to the advantageous effects listed above. For example, there may be a variety of technical effects that a person having ordinary skill in the related art can understand and/or derive from the present specification. Accordingly, the specific effects of the present specification are not limited to those explicitly described herein, but may include various effects that may be understood or derived from the technical features of the present specification.

### BRIEF DESCRIPTION OF THE DRAWINGS

FIG. 1 illustrates an example of a communication system to which implementations of the present specification is applied.

FIG. 2 shows an example of a wireless device to which the implementation of the present specification is applied.

FIG. 3 shows another example of a wireless device to which the implementation of the present specification is applied.

FIG. 4 shows an example of a UE to which the implementation of the present specification is applied.

FIG. 5 shows an example of an air interface user plane protocol stack between a UE and a BS.

FIG. 6 shows an example of a radio interface control plane protocol stack between a UE and a BS.

FIG. 7 illustrates physical channels and general signal transmission used in a 3GPP system.

FIG. 8 shows an example of a frame structure in a 3GPP-based wireless communication system.

FIG. 9 shows an example of a slot structure of a frame.

FIG. 10 illustrates UE operation according to multi-TTI scheduling.

FIG. 11 illustrates a 5G NR downlink MAC PDU.

FIG. 12 illustrates a 5G NR uplink MAC PDU.

FIG. 13 illustrates the process of determining the Transport Block Size (TBS).

FIG. 14 illustrates a downlink transmission structure for improving MAC CE transmission reliability.

FIG. 15 illustrates an uplink transmission structure for improving MAC CE transmission reliability.

FIG. 16 shows an example of determining the size of a first transport block (PTB) and the size of a second transport block (STB).

FIG. 17 is a schematic diagram of the procedure described in Equations 12 through 20.

FIG. 18 illustrates a procedure for reducing the error between the N_{CB} and the final number of code blocks by applying the procedure for obtaining the number of code blocks in FIG. 13 when obtaining the N_{CB}.

FIG. 19 illustrates a procedure for obtaining the size of PTB, the size of STB, and the number of CBs.

FIG. 20 illustrates a method for transmitting a transport block of a device in a wireless communication system.

FIG. 21 illustrates signaling and operation between a first device and a second device in a wireless communication system.

FIG. 22 illustrates an operation method of the first device (base station).

### DETAILED DESCRIPTION

Techniques, apparatuses, and systems to be described below may be applied to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access (UTRA) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi). IEEE 802.16 (WiMAX). IEEE 802.20, or Evolved UTRA (E-UTRA). UTRA is part of the Universal Mobile Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

For convenience of description, implementations of the present specification are mainly described in the context of a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other mobile communication systems.

For terms and techniques not specifically described among terms and techniques used in this specification, reference may be made to a wireless communication standard document issued before this specification.

In this specification, “A or B” may mean “only A”, “only B”, or “both A and B”. In other words, “A or B” herein may be interpreted as “A and/or B”. For example. “A, B or C” herein means “only A”, “only B”, “only C”, or “any and any combination of A, B and C”.

As used herein, a slash (/) or a comma (comma) may mean “and/or”. For example, “A/B” may mean “A and/or B”. Accordingly, “A/B” may mean “only A”, “only B”, or “both A and B”. For example, “A, B, C” may mean “A, B, or C”.

As used herein, “at least one of A and B” may mean “only A”, “only B”, or “both A and B”. In addition, in this specification, the expression “at least one of A or B” or “at least one of A and/or B” means “at least one of A and B”.

Also, as used herein, “at least one of A, B and C” means “only A”, “only B”, “only C”, or “any combination of A, B and C”. In addition, “at least one of A, B or C” or “at least one of A, B and/or C” means can mean “at least one of A, B and C”.

In addition, parentheses used herein may mean “for example”. Specifically, when displayed as “control information (PDCCH)”, “PDCCH” may be proposed as an example of “control information”. In other words, “control information” in the present specification is not limited to “PDCCH”, and “PDCCH” may be proposed as an example of “control information”. In addition, even when displayed as “control information (i.e., PDCCH)”, “PDCCH” may be proposed as an example of “control information”.

Technical features that are individually described in one drawing in this specification may be implemented individually or may be implemented at the same time.

Although not limited thereto, the various descriptions, functions, procedures, proposals, methods, and/or operation flowcharts disclosed herein may be applied to various fields requiring wireless communication and/or connection (e.g., 5G) between devices.

Hereinafter, the present specification will be described in more detail with reference to the drawings. In the following drawings and/or descriptions, the same reference numbers may refer to the same or corresponding hardware blocks, software blocks, and/or functional blocks unless otherwise indicated.

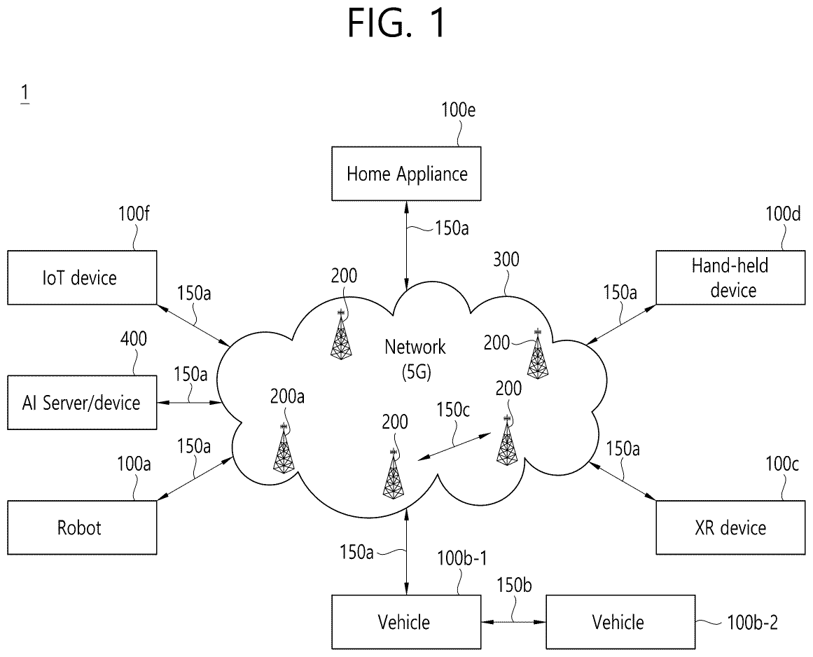

FIG. 1 shows an example of a communication system to which an implementation of the present specification is applied.

The 5G usage scenario shown in FIG. 1 is only an example, and the technical features of the present specification may be applied to other 5G usage scenarios not shown in FIG. 1.

The three main requirements categories for 5G are (1) enhanced Mobile BroadBand (eMBB) category, (2) massive Machine Type Communication (mMTC) category, and (3) ultra-reliable, low-latency communication. (URLLC: Ultra-Reliable and Low Latency Communications) category.

Referring to FIG. 1, the communication system 1 includes wireless devices 100a˜100f, base station 200, and a network 300. Although FIG. 1 illustrates a 5G network as an example of the network of the communication system 1, the implementations of the present disclosure are not limited to the 5G system, and can be applied to the future communication system beyond the 5G system.

The BS 200 and the network 300 may be implemented as wireless devices and a specific wireless device may operate as a BS/network node with respect to other wireless devices.

The wireless devices 100a˜100f, represent devices performing communication using radio access technology (RAT) (e.g., 5G New RAT (NR)) or Long-Term Evolution (LTE)) and may be referred to as communication/radio/5G devices. The wireless devices 100a˜100f may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present specification, the wireless devices 100a˜100f may be called user equipments (UEs). A user equipment (UE) may include, for example, a cellular phone, a smartphone, a laptop computer, a digital broadcast, a personal digital assistant (PDA), a portable multimedia player (PMP), a navigation system, a slate personal computer (PC), a tablet PC, an ultrabook, a vehicle, a vehicle having an autonomous traveling function, a connected car, an unmanned aerial vehicle (UAV), an artificial intelligence (AI) module, a robot, an augmented reality (AR) device, a virtual reality (VR) device, a mixed reality (MR) device, a hologram device, a public safety device, an MTC device, an IoT device, a medical device, a FinTech device (or a financial device), a security device, a weather/environment device, a device related to a 5G service, or a device related to a fourth industrial revolution field.

For example, the unmanned aerial vehicle (UAV) may be an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a CCTV, a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f/BS 200-BS 200. Herein, the wireless communication/connections may be established through various RATs (e.g., 5G NR) such as uplink/downlink communication 150a and sidelink communication 150b (or D2D communication). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

AI refers to a field that studies artificial intelligence or a methodology that can create it, and machine learning refers to a field that defines various problems dealt with in the field of artificial intelligence and studies methodologies to solve them. Machine learning is also defined as an algorithm that improves the performance of a certain task through constant experience.

A robot can mean a machine that automatically handles or operates a task given by its own capabilities. In particular, a robot having a function of recognizing an environment and performing an operation by self-judgment may be referred to as an intelligent robot. Robots can be classified into industrial, medical, home, military, etc. according to the purpose or field of use. The robot may be provided with a driving unit including an actuator or a motor to perform various physical operations such as moving the robot joints. In addition, the movable robot includes a wheel, a brake, a propeller, and the like in the driving unit, and can travel on the ground or fly in the air through the driving unit.

Autonomous driving refers to a technology that drives by itself, and an autonomous driving vehicle refers to a vehicle that runs without or with minimal manipulation of a user. For example, autonomous driving may include all technologies that maintains a driving lane, technology that automatically adjusts speed such as adaptive cruise control, technology that automatically drives along a predetermined route, and technology that automatically sets a route when a destination is set etc. The vehicle includes a vehicle having only an internal combustion engine, a hybrid vehicle having both an internal combustion engine and an electric motor, and an electric vehicle having only an electric motor, and may include not only automobiles, but also trains, motorcycles, and the like. Autonomous vehicles can be viewed as robots with autonomous driving capabilities.

Augmented reality refers to VR, AR, and MR. VR technology provides objects and backgrounds in the real world only as CG images, AR technology provides virtual CG images on top of real objects. MR technology is a CG technology that mixes and combines virtual objects with the real world. MR technology is similar to AR technology in that it shows both real and virtual objects. However, there is a difference in that in AR technology, a virtual object is used in a form that complements a real object, whereas in MR technology, a virtual object and a real object are used with equal characteristics.

NR supports multiple numerology or, subcarrier spacing (SCS) to support various 5G services. For example, when the SCS is 15 kHz, wide area in traditional cellular bands may be supported. When the SCS is 30 KHz/60 KHz, dense-urban, lower latency and wider carrier bandwidth may be supported. When the SCS is 60 kHz or higher, a bandwidth greater than 24.25 GHz may be supported to overcome phase noise.

The NR frequency band may be defined as two types of frequency range, i.e., FRI and FR2. The numerical value of the frequency range may be changed. For example, the frequency ranges of the two types (FRI and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| | Corresponding | |
|---|---|---|
| Frequency Range | frequency | |
| designation | range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| | Corresponding | |
|---|---|---|
| Frequency Range | frequency | |
| designation | range | Subcarrier Spacing |
| FR1 | 410 MHz-7125 MHz | 15, 30, 60 kHz |
| FR2 | 24250 MHz-52600 MHz | 60, 120, 240 kHz |

Here, the wireless communication technology implemented in the wireless device of the present specification may include narrowband IoT (NB-IoT) for low-power communication as well as LTE, NR, and 6G. For example, the NB-IoT technology may be an example of a LPWAN (Low Power Wide Area Network) technology, and may be implemented in standards such as LTE Cat NB1 and/or LTE Cat NB2, and is not limited to the above-mentioned name. Additionally or alternatively, the wireless communication technology implemented in the wireless device of the present specification may perform communication based on LTE-M technology. For example, the LTE-M technology may be an example of an LPWAN technology, and may be called by various names such as enhanced MTC (eMTC). For example, LTE-M technology may be implemented in at least one of various standards such as 1) LTE CAT 0, 2) LTE Cat M1, 3) LTE Cat M2, 4) LTE non-BL (Non-Bandwidth Limited), 5) LTE-MTC, 6) LTE MTC, and/or 7) LTE M, and is not limited to the above-described name. Additionally or alternatively, the wireless communication technology implemented in the wireless device of the present specification may include at least one of ZigBee, Bluetooth, and/or LPWAN in consideration of low-power communication, and it is not limited to the above-mentioned names. For example, the ZigBee technology may create PANs (Personal Area Networks) related to small/low-power digital communication based on various standards such as IEEE 802.15.4, and may be called by various names.

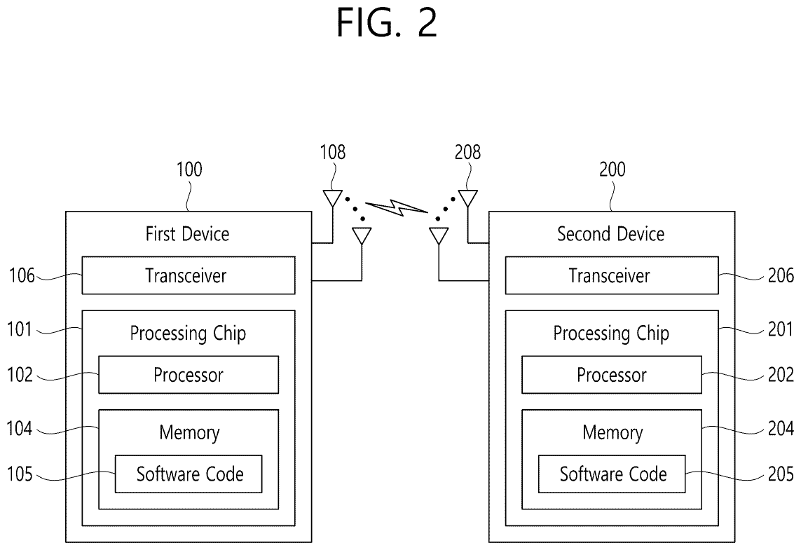

FIG. 2 shows an example of a wireless device to which the implementation of the present specification is applied.

Referring to FIG. 2, the first wireless device 100 and the second wireless device 200 may transmit/receive radio signals to/from an external device through various RATs (e.g., LTE and NR).

In FIG. 2, {first wireless device 100 and second wireless device 200} may correspond to at least one of {wireless devices 100a to 100f and base station 200}, {wireless device 100a to 100f and wireless devices 100a to 100f} and/or {base station 200 and base station 200} in FIG. 1.

The first wireless device 100 may include at least one transceiver, such as a transceiver 106, at least one processing chip, such as a processing chip 101, and/or one or more antennas 108.

Processing chip 101 may include at least one processor, such as processor 102, and at least one memory, such as memory 104. In FIG. 2, an example in which the memory 104 is included in the processing chip 101 is shown. Additionally and/or alternatively, the memory 104 may be located external to the processing chip 101.

The processor 102 may control the memory 104 and/or the transceiver 106 and may be configured to implement the descriptions, functions, procedures, suggestions, methods, and/or operational flow diagrams disclosed herein. For example, the processor 102 may process information in the memory 104 to generate first information/signal, and transmit a wireless signal including the first information/signal through the transceiver 106. The processor 102 may receive a wireless signal including the second information/signal through the transceiver 106, and store information obtained by processing the second information/signal in the memory 104.

Memory 104 may be operatively coupled to processor 102. Memory 104 may store various types of information and/or instructions. The memory 104 may store software code 105 that, when executed by the processor 102, implements instructions that perform the descriptions, functions, procedures, suggestions, methods, and/or operational flow diagrams disclosed herein. For example, the software code 105 may implement instructions that, when executed by the processor 102, perform the descriptions, functions, procedures, suggestions, methods, and/or operational flow diagrams disclosed herein. For example, software code 105 may control processor 102 to perform one or more protocols. For example, software code 105 may control processor 102 to perform one or more air interface protocol layers.

Here, the processor 102 and the memory 104 may be part of a communication modem/circuit/chip designed to implement a RAT (e.g., LTE or NR). The transceiver 106 may be coupled to the processor 102 to transmit and/or receive wireless signals via one or more antennas 108. Each transceiver 106 may include a transmitter and/or a receiver. The transceiver 106 may be used interchangeably with a radio frequency (RF) unit. In this specification, the first wireless device 100 may represent a communication modem/circuit/chip.

The second wireless device 200 may include at least one transceiver, such as a transceiver 206, at least one processing chip, such as a processing chip 201, and/or one or more antennas 208.

Processing chip 201 may include at least one processor, such as processor 202, and at least one memory, such as memory 204. In FIG. 2 shows an example in which the memory 204 is included in the processing chip 201. Additionally and/or alternatively, the memory 204 may be located external to the processing chip 201.

The processor 202 may control the memory 204 and/or the transceiver 206 and may be configured to implement the descriptions, functions, procedures, suggestions, methods, and/or operational flow diagrams disclosed herein. For example, the processor 202 may process the information in the memory 204 to generate third information/signal, and transmit a wireless signal including the third information/signal through the transceiver 206. The processor 202 may receive a radio signal including the fourth information/signal through the transceiver 206, and store information obtained by processing the fourth information/signal in the memory 204.

Memory 204 may be operatively coupled to processor 202. Memory 204 may store various types of information and/or instructions. The memory 204 may store software code 205 that, when executed by the processor 202, implements instructions that perform the descriptions, functions, procedures, suggestions, methods, and/or operational flow diagrams disclosed herein. For example, the software code 205 may implement instructions that, when executed by the processor 202, perform the descriptions, functions, procedures, suggestions, methods, and/or operational flow diagrams disclosed herein. For example, software code 205 may control processor 202 to perform one or more protocols. For example, software code 205 may control processor 202 to perform one or more air interface protocol layers.

Here, the processor 202 and the memory 204 may be part of a communication modem/circuit/chip designed to implement a RAT (e.g., LTE or NR). The transceiver 206 may be coupled to the processor 202 to transmit and/or receive wireless signals via one or more antennas 208. Each transceiver 206 may include a transmitter and/or a receiver. The transceiver 206 may be used interchangeably with the RF unit. In this specification, the second wireless device 200 may represent a communication modem/circuit/chip.

Hereinafter, hardware elements of the wireless devices 100 and 200 will be described in more detail. Although not limited thereto, one or more protocol layers may be implemented by one or more processors 102, 202. For example, the one or more processors 102, 202 may implement one or more layers (e.g., functional layers such as a physical (PHY) layer, a Media Access Control (MAC) layer, a Radio Link Control (RLC) layer, a Packet Data Convergence Protocol (PDCP) layer, a Radio Resource Control (RRC) layer or a Service Data Adaptation Protocol (SDAP) layer). The one or more processors 102, 202 generate one or more Protocol Data Units (PDUs) and/or one or more Service Data Units (SDUs) according to the descriptions, functions, procedures, proposals, methods, and/or operational flow diagrams disclosed herein. One or more processors 102, 202 may generate messages, control information, data, or information in accordance with the descriptions, functions, procedures, proposals, methods, and/or operational flow diagrams disclosed herein. The one or more processors 102, 202 may configure a signal including a PDU, SDU, message, control information, data or information (e.g., a baseband signal) and provide it to one or more transceivers (106, 206). One or more processors 102, 202 may receive signals (e.g., baseband signals) from one or more transceivers 106, 206, PDU, SDU, message, control information, data or information may be obtained according to the description, function, procedure, proposal, method, and/or operation flowchart disclosed herein.

One or more processors 102, 202 may be referred to as controllers, microcontrollers, microprocessors, and/or microcomputers. One or more processors 102, 202 may be implemented by hardware, firmware, software, and/or a combination thereof. For example, one or more Application Specific Integrated Circuits (ASICs), one or more Digital Signal Processors (DSPs), one or more Digital Signal Processing Devices (DSPDs), one or more Programmable Logic Devices (PLDs), and/or one or more Field Programmable Gates (FPGAs) Arrays) may be included in one or more processors 102, 202. The descriptions, functions, procedures, suggestions, methods, and/or flow diagrams disclosed herein may be implemented using firmware and/or software, and the firmware and/or software may be implemented to include modules, procedures, functions. Firmware or software configured to perform the descriptions, functions, procedures, suggestions, methods, and/or operational flow charts disclosed herein may be included in one or more processors 102, 202, or stored in one or more memories 104, 204, and it may be driven by the above processors 102 and 202. The descriptions, functions, procedures, proposals, methods, and/or flow diagrams disclosed herein may be implemented using firmware or software in the form of code, instructions, and/or sets of instructions.

One or more memories 104, 204 may be coupled with one or more processors 102, 202 and may store various forms of data, signals, messages, information, programs, code, instructions, and/or instructions. The one or more memories 104, 204 may include read-only memory (ROM), random access memory (RAM), erasable programmable ROM (EPROM), flash memory, hard drives, registers, cache memory, computer readable storage media and/or it may consist of a combination of these. One or more memories 104, 204 may be located inside and/or external to one or more processors 102, 202. In addition, one or more memories 104, 204 may be coupled to one or more processors 102, 202 through various technologies, such as wired or wireless connections.

The one or more transceivers 106, 206 may transmit user data, control information, wireless signals/channels, etc, referred to in the descriptions, functions, procedures, suggestions, methods, and/or operational flow diagrams disclosed herein to one or more other devices. The one or more transceivers 106, 206 may receive user data, control information, radio signals/channels, etc, referred to in the descriptions, functions, procedures, suggestions, methods, and/or flow charts disclosed herein, from one or more other devices. For example, one or more transceivers 106, 206 may be coupled to one or more processors 102, 202 and may transmit and receive wireless signals. For example, one or more processors 102, 202 may control one or more transceivers 106, 206 to transmit user data, control information, wireless signals, etc, to one or more other devices. In addition, one or more processors 102, 202 may control one or more transceivers 106, 206 to receive user data, control information, radio signals, etc, from one or more other devices.

One or more transceivers 106, 206 may be coupled to one or more antennas 108, 208. One or more transceivers 106, 206 may be configured to transmit and receive to user data, control information, radio signals/channels referred to in the descriptions, functions, procedures, proposals, methods, and/or operational flow diagrams disclosed herein via one or more antennas 108, 208. Herein, the one or more antennas 108 and 208 may be a plurality of physical antennas or a plurality of logical antennas (e.g., antenna ports).

The one or more transceivers 106 and 206 may convert received user data, control information, radio signals/channels, etc, from RF band signals to baseband signals to process the received user data, control information, radio signals/channels, etc, using the one or more processors 102, 202. One or more transceivers 106 and 206 may convert user data, control information, radio signals/channels, etc, processed using one or more processors 102 and 202 from baseband signals to RF band signals. To this end, one or more transceivers 106, 206 may include (analog) oscillators and/or filters. For example, one or more transceivers 106, 206 up-convert OFDM baseband signals to OFDM signals via (analog) oscillators and/or filters under the control of one or more processors 102, 202, and may transmit an up-converted OFDM signal at a carrier frequency. One or more transceivers (106, 206) receive the OFDM signal at the carrier frequency and down-convert the OFDM signal to an OFDM baseband signal through an (analog) oscillator and/or filter under the control of one or more processors (102, 202).

In the implementation of the present specification, the UE may operate as a transmitting device in uplink (UL) and as a receiving device in downlink (DL). In the implementation of the present specification, the base station may operate as a receiving device in the UL and a transmitting device in the DL. Hereinafter, for technical convenience, it is mainly assumed that the first wireless device 100 operates as a UE and the second wireless device 200 operates as a base station. For example, the processor 102 connected to, mounted on, or released to the first wireless device 100 may be configured to control the transceiver 106 to perform a UE operation according to an implementation of the present specification or configured to perform a UE operation according to an implementation of the present specification. The processor 202 connected to, mounted on, or released to the second wireless device 200 may be configured to control the transceiver 206 to perform a BS operation according to an implementation of the present specification or configured to perform a BS operation according to an implementation of the present specification.

In this specification, the base station may be referred to as another term such as a Node B (Node B), an eNode B (eNB), a gNB, and the like.

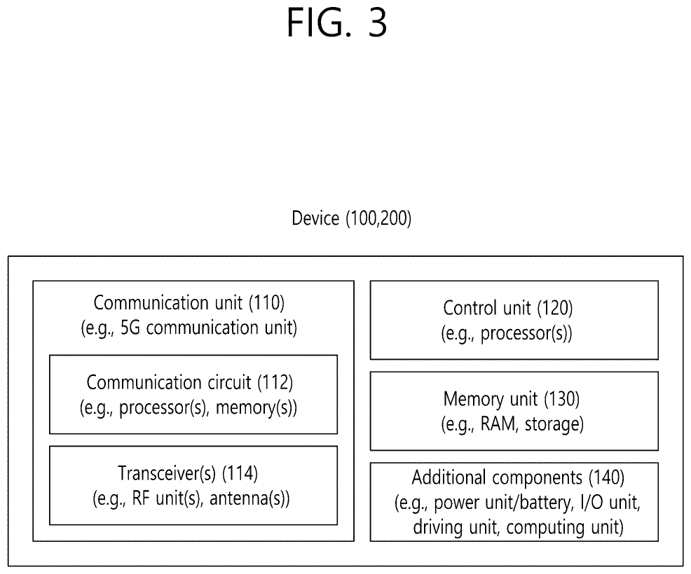

FIG. 3 shows another example of a wireless device to which the implementation of the present specification is applied.

The wireless device may be implemented in various forms according to usage examples/services.

Referring to FIG. 3, the wireless devices 100 and 200 may correspond to the wireless devices 100 and 200 of FIG. 2, and may be configured by various components, devices/parts and/or modules. For example, each wireless device 100, 200 may include a communication device 110, a control device 120, a memory device 130, and an additional component 140. The communication device 110 may include communication circuitry 112 and a transceiver 114. For example, communication circuitry 112 may include one or more processors 102, 202 of FIG. 2 and/or one or more memories 104, 204 of FIG. 2. For example, transceiver 114 may include one or more transceivers 106, 206 of FIG. 2 and/or one or more antennas 108, 208 of FIG. 2. The control device 120 is electrically connected to the communication device 110, the memory device 130, and the additional component 140, and controls the overall operation of each wireless device 100, 200. For example, the control device 120 may control the electrical/mechanical operation of each of the wireless devices 100 and 200 based on the program/code/command/information stored in the memory device 130. The control device 120 transmits information stored in the memory device 130 to the outside (e.g., other communication devices) through the communication device 110 through a wireless/wired interface, or the control device 120 may store information received from the outside (e.g., other communication devices) through the communication device 110 through the wireless/wired interface in the memory device 130.

The additional component 140 may be variously configured according to the type of the wireless device 100 or 200. For example, the additional component 140 may include at least one of a power unit/battery, an input/output (I/O) device (e.g., an audio I/O port, a video I/O port), a drive unit, and a computing device. The wireless devices 100 and 200 may be implemented, not limited to, a robot (100a in FIG. 1), a vehicle (100b-1 and 100b-2 in FIG. 1), an XR device (100c in FIG. 1), and a portable device (100d in FIG. 1), home appliances (100e in FIG. 1), IoT devices (100f in FIG. 1), digital broadcast terminals, hologram devices, public safety devices, MTC devices, medical devices, fintech devices (or financial devices), security devices, a climate/environment device, an AI server/device (400 in FIG. 1), a base station (200 in FIG. 1), and a network node. The wireless devices 100 and 200 may be used in a moving or fixed location according to usage examples/services.

In FIG. 3, all of the various components, devices/parts and/or modules of the wireless devices 100 and 200 may be connected to each other via a wired interface, or at least some of them may be wirelessly connected via the communication device 110. For example, in each of the wireless devices 100 and 200, the control device 120 and the communication device 110 are connected by wire, and the control device 120 and the first device (e.g., 130 and 140) may be wirelessly connected through the communication device 110. Each component, device/portion and/or module within the wireless device 100, 200 may further include one or more elements. For example, the control device 120 may be configured by one or more processor sets. For example, the control device 120 may be configured by a set of a communication control processor, an application processor (AP), an electronic control unit (ECU), a graphic processing unit, and a memory control processor. As another example, the memory device 130 may be configured by RAM, dynamic RAM (DRAM), ROM, flash memory, volatile memory, non-volatile memory, and/or a combination thereof.

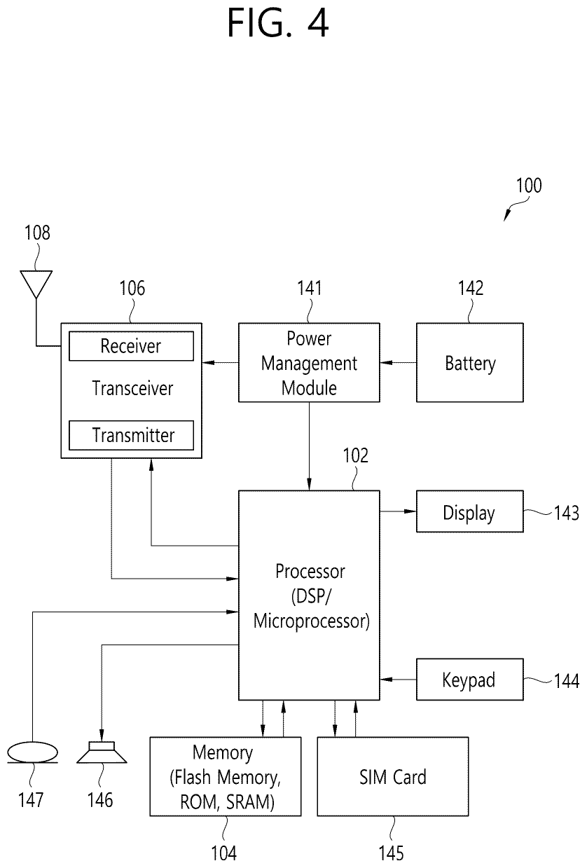

FIG. 4 shows an example of a UE to which the implementation of the present specification is applied.

Referring to FIG. 4, the UE 100 may correspond to the first wireless device 100 of FIG. 2 and/or the wireless device 100 or 200 of FIG. 3.

The UE 100 may include a processor 102, a memory 104, a transceiver 106, one or more antennas 108, a power management module 141, a battery 142, a display 143, a keypad 144, a SIM (Subscriber Identification Module) card 145, a speaker 146, and a microphone 147.

The processor 102 may be configured to implement the descriptions, functions, procedures, suggestions, methods, and/or operational flow diagrams disclosed herein. The processor 102 may be configured to control one or more other components of the UE 100 to implement the descriptions, functions, procedures, suggestions, methods, and/or operational flow diagrams disclosed herein. A layer of air interface protocol may be implemented in the processor 102. The processor 102 may include an ASIC, other chipset, logic circuitry, and/or data processing device. The processor 102 may be an application processor. The processor 102 may include at least one of a DSP, a central processing unit (CPU), a graphics processing unit (GPU), and a modem (modulator and demodulator).

The memory 104 is operatively coupled to the processor 102, and stores various information for operating the processor 102. Memory 104 may include ROM, RAM, flash memory, memory cards, storage media, and/or other storage devices. When the implementation is implemented in software, the techniques described herein may be implemented using modules (e.g., procedures, functions, etc.) that perform the descriptions, functions, procedures, suggestions, methods, and/or operational flow diagrams disclosed herein. Modules may be stored in memory 104 and executed by processor 102. The memory 104 may be implemented within the processor 102 or external to the processor 102. In this case, it may be communicatively coupled to the processor 102 through various methods known in the art.

The transceiver 106 is operatively coupled with the processor 102 and transmits and/or receives wireless signals. The transceiver 106 includes a transmitter and a receiver. The transceiver 106 may include baseband circuitry for processing radio frequency signals. The transceiver 106 controls one or more antennas 108 to transmit and/or receive wireless signals.

The power management module 141 manages power of the processor 102 and/or the transceiver 106. The battery 142 supplies power to the power management module 141.

The display 143 outputs the result processed by the processor 102. Keypad 144 receives input for use by processor 102. The keypad 144 may be displayed on the display 143.

The SIM card 145 is an integrated circuit for securely storing an International Mobile Subscriber Identity (IMSI) and related keys, and is used to identify and authenticate subscribers in a mobile phone device such as a mobile phone or computer. It is also possible to store contact information on many SIM cards.

The speaker 146 outputs sound related results processed by the processor 102. Microphone 147 receives sound related input for use by processor 102.

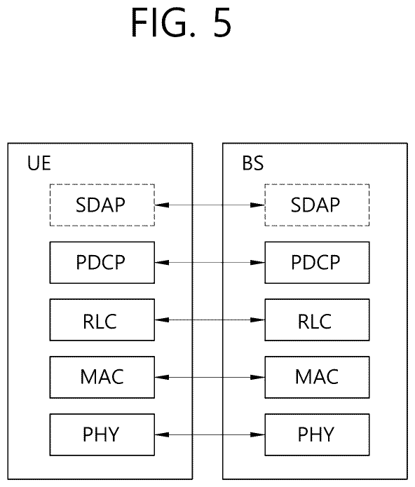

FIG. 5 shows an example of an air interface user plane protocol stack between a UE and a BS. Referring to FIG. 5, the user plane protocol stack may be divided into a layer 1 (i.e., a PHY layer) and a layer 2. The user plane refers to a path through which data generated in the application layer, for example, voice data or Internet packet data is transmitted.

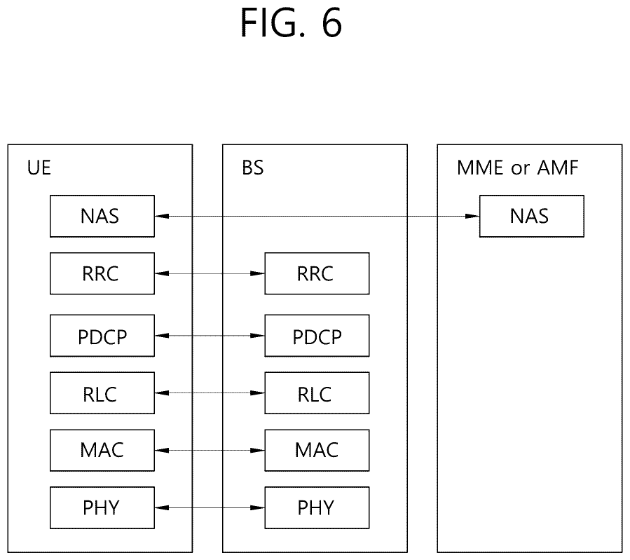

FIG. 6 shows an example of a radio interface control plane protocol stack between a UE and a BS. The control plane refers to a path through which a control message used by the UE and the network to manage a call is transmitted. Referring to FIG. 6, the control plane protocol stack may be divided into a layer 1 (i.e., a PHY layer), a layer 2, a layer 3 (e.g., an RRC layer), and a non-access stratum (NAS) layer. Layer 1, Layer 2, and Layer 3 are referred to as Access Stratum (AS).

In the 3GPP LTE system, Layer 2 is divided into sublayers of MAC, RLC, and PDCP. In the 3GPP NR system. Layer 2 is divided into sublayers of MAC, RLC, PDCP and SDAP. The PHY layer provides a transport channel to the MAC sublayer, the MAC sublayer provides a logical channel to the RLC sublayer, the RLC sublayer provides an RLC channel to the PDCP sublayer, and the PDCP sublayer provides a radio bearer to the SDAP sublayer. The SDAP sublayer provides QoS (Quality Of Service) flows to the 5G core network.

The main services and functions of the MAC sublayer in the 3GPP NR system include mapping between logical channels and transport channels; multiplexing/demultiplexing MAC SDUs belonging to one or another logical channel to/from a Transport Block (TB) delivered to/from a physical layer on a transport channel; reporting scheduling information: error correction via Hybrid Automatic Repeat Request (HARQ) (one HARQ entity per cell in case of CA (Carrier Aggregation)); priority processing between UEs by dynamic scheduling; priority processing between logical channels of one UE by logical channel prioritization; and padding. A single MAC entity may support multiple numerologies, transmission timings and cells. Mapping constraints in logical channel prioritization control the numerologies, cells, and transmission timing that logical channels can use.

MAC provides various types of data transmission services. To accommodate different kinds of data transfer services, different types of logical channels are defined. That is, each logical channel supports the transmission of a specific type of information. Each logical channel type is defined according to the type of information being transmitted. Logical channels are classified into two groups: control channels and traffic channels. The control channel is used only for transmission of control plane information, and the traffic channel is used only for transmission of user plane information. A Broadcast Control Channel (BCCH) is a downlink logical channel for broadcasting system control information. A Paging Control Channel (PCCH) is a downlink logical channel for transmitting paging information system information change notification, and indication of an ongoing Public Warning Service (PWS) broadcast. A common control channel (CCCH) is a logical channel for transmitting control information between a UE and a network, and is used for a UE without an RRC connection to the network. A DCCH (Dedicated Control Channel) is a point-to-point bidirectional logical channel for transmitting dedicated control information between a UE and a network, and is used by a UE having an RRC connection. A Dedicated Traffic Channel (DTCH) is a point-to-point logical channel dedicated to one UE for transmitting user information. DTCH may exist in both uplink and downlink. The following connection exists between the logical channel and the transport channel in the downlink. The BCCH may be mapped to a broadcast channel (BCH), the BCCH may be mapped to a downlink shared channel (DL-SCH), the PCCH may be mapped to a paging channel (PCH), and the CCCH may be mapped to the DL-SCH, DCCH may be mapped to DL-SCH, and DTCH may be mapped to DL-SCH. The following connection exists between the logical channel and the transport channel in the uplink. The CCCH may be mapped to an Uplink Shared Channel (UL-SCH), the DCCH may be mapped to the UL-SCH, and the DTCH may be mapped to the UL-SCH.

The RLC sublayer supports three transmission modes: TM (Transparent Mode). UM (Unacknowledged Mode), and AM (Acknowledged Mode). RLC configuration is done for each logical channel that does not depend on the numerology and/or transmission period. In the 3GPP NR system, the main services and functions of the RLC sublayer depend on the transmission mode, and include the transmission of the higher layer PDU: sequence numbering independent of that in PDCP (UM and AM); error correction via ARQ (AM only) RLC SDU splitting (AM and UM) and repartitioning (AM only); reassembly of SDUs (AM and UM); duplicate detection (AM only); RLC SDU discard (AM and UM); RLC re-establishment; and protocol error detection (AM only).

In the 3GPP NR system, the main services and functions of the PDCP sublayer for the user plane include: sequence numbering: header compression and decompression using ROHC (Robust Header Compression); user data transmission; reordering and duplicate detection; in-order delivery; PDCP PDU routing (for split bearers); retransmission of PDCP SDUs; encryption, decryption and integrity protection; PDCP SDU discard; PDCP re-establishment and data recovery for RLC AM; PDCP status report for RLC AM; replication of PDCP PDUs and indication of abort replication to lower layers. The main services and functions of the PDCP sublayer for the control plane include; sequence numbering; encryption, decryption and integrity protection; control plane data transmission; reordering and duplicate detection; delivery in order; replication of PDCP PDUs and indication of abort replication to lower layers.

The main services and functions of SDAP in the 3GPP NR system include: mapping between QoS flows and data radio bearers: an indication of QoS Flow ID (QFI) in both DL and UL packets. A single protocol entity in SDAP is configured for each individual PDU session.

In the 3GPP NR system, the main services and functions of the RRC sublayer include: broadcasting of system information related to AS and NAS; paging initiated by 5GC or NG-RAN; establishment, maintenance and release of RRC connection between the UE and the NG-RAN; security features including key management: establishment, configuration, maintenance and release of a Signaling Radio Bearer (SRB) and a Data Radio Bearer (DRB); mobility functions (including handover and context transfer. UE cell selection and reselection and control of cell selection and reselection, inter-RAT mobility); QoS management function; UE measurement report and report control; detection and recovery of radio link failures; sending NAS messages to/from the UE to/from the NAS.

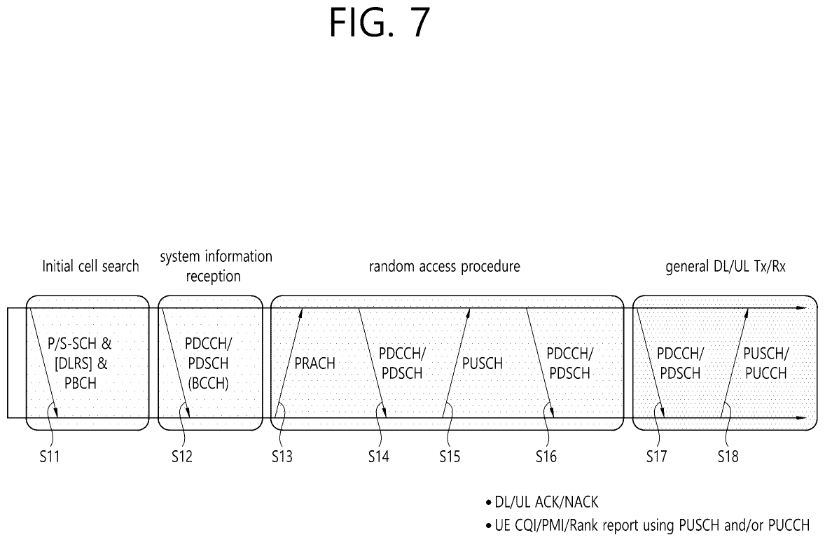

FIG. 7 illustrates physical channels and general signal transmission used in a 3GPP system.

Referring to FIG. 7, in a wireless communication system, a UE receives information from a base station through a downlink (DL), and the UE transmits information to a base station through an uplink (UL). The information transmitted and received between the base station and the UE includes data and various control information, and various physical channels exist according to the type/use of the information they transmit and receive.

When the UE is powered on or newly enters a cell, the UE performs an initial cell search operation such as synchronizing with the base station (S11). To this end, the UE receives a primary synchronization signal (PSS) and a secondary synchronization signal (SSS) from the base station, synchronizes with the base station, and obtains information such as a cell ID. Thereafter, the UE may receive a physical broadcast channel (PBCH) from the base station to obtain intra-cell broadcast information. Meanwhile, the UE may receive a downlink reference signal (DL RS) in the initial cell search step to check the downlink channel state.

After the initial cell search, the UE may receive a Physical Downlink Control Channel (PDCCH) and a Physical Downlink Control Channel (PDSCH) according to information carried on the PDCCH to obtain more specific system information (S12).

On the other hand, when accessing the base station for the first time or there is no radio resource for signal transmission, the UE may perform a random access procedure (RACH) to the base station (S13 to S16). To this end, the UE transmits a specific sequence as a preamble through a Physical Random Access Channel (PRACH) (S13 and S15), a response message ((Random Access Response (RAR) message) for the preamble may be received through the PDCCH and the corresponding PDSCH. In the case of contention-based RACH, a contention resolution procedure may be additionally performed (S16).

After performing the procedure as described above, the UE may perform PDCCH/PDSCH reception (S17) and Physical Uplink Shared Channel (PUSCH)/Physical Uplink Control Channel (PUCCH) transmission (S18) as a general uplink/downlink signal transmission procedure. In particular, the UE may receive downlink control information (DCI) through the PDCCH. Here, the DCI includes control information such as resource allocation information for the UE, and different formats may be applied according to the purpose of use.

On the other hand, the control information transmitted by the UE to the base station through the uplink or received by the UE from the base station is a downlink/uplink ACK/NACK signal, a channel quality indicator (CQI), a precoding matrix index (PMI), and a rank indicator (RI) and the like. The UE may transmit the above-described control information such as CQI/PMI/RI through PUSCH and/or PUCCH.

### <Structure of Uplink and Downlink Channels>

### 1. Downlink Channel Structure

The base station may transmit a related signal to the UE through a downlink channel to be described later, and the UE may receive a related signal from the base station through a downlink channel to be described later.

### (1) Physical Downlink Shared Channel (PDSCH)

PDSCH carries downlink data (e.g., DL-shared channel transport block, DL-SCH TB), and modulation methods such as Quadrature Phase Shift Keying (QPSK), 16 Quadrature Amplitude Modulation (QAM), 64 QAM, and 256 QAM are applied to the PDSCH. A codeword is generated by encoding a transport block (TB). A PDSCH can carry multiple codewords. Scrambling and modulation mapping are performed for each codeword, and modulation symbols generated from each codeword are mapped to one or more layers (Layer mapping). Each layer is mapped to a resource together with a demodulation reference signal (DMRS), is generated as an OFDM symbol signal, and is transmitted through a corresponding antenna port.

### (2) Physical Downlink Control Channel (PDCCH)

The PDCCH carries downlink control information (DCI) and a QPSK modulation method is applied. One PDCCH is composed of 1, 2, 4, 8, 16 CCEs (Control Channel Elements) according to an Aggregation Level (AL). One CCE consists of six REGs (Resource Element Groups). One REG is defined as one OFDM symbol and one (P)RB.

The UE obtains DCI transmitted through the PDCCH by performing decoding (also known as, blind decoding) on a set of PDCCH candidates. A set of PDCCH candidates decoded by the UE is defined as a PDCCH search space set. The search space set may be a common search space or a UE-specific search space. The UE may acquire DCI by monitoring PDCCH candidates in one or more search space sets configured by MIB or higher layer signaling.

### 2. Uplink Channel Structure

The UE transmits a related signal to the base station through an uplink channel to be described later, and the base station receives the related signal from the UE through an uplink channel to be described later.

### (1) Physical Uplink Shared Channel (PUSCH)

PUSCH carries uplink data (e.g., UL-shared channel transport block, UL-SCH TB) and/or uplink control information (UCI), and is transmitted based on the waveform such as CP-OFDM (Cyclic Prefix-Orthogonal Frequency Division Multiplexing) waveform. DFT-s-OFDM (Discrete Fourier Transform-spread-Orthogonal Frequency Division Multiplexing) waveform, etc. When the PUSCH is transmitted based on the DFT-s-OFDM waveform, the UE transmits the PUSCH by applying transform precoding. For example, when transform precoding is not possible (e.g., transform precoding is disabled), the UE transmits a PUSCH based on a CP-OFDM waveform, and when transform precoding is possible (e.g., transform precoding is enabled), the UE may transmit a PUSCH based on a CP-OFDM waveform or a DFT-s-OFDM waveform. PUSCH transmission is dynamically scheduled by a UL grant in DCI, or may be semi-statically scheduled (configured grant) based on higher layer (e.g., RRC) signaling (and/or Layer 1 (L1) signaling (e.g., PDCCH)). PUSCH transmission may be performed on a codebook-based or non-codebook-based basis.

### (2) Physical Uplink Control Channel (PUCCH)

The PUCCH carries uplink control information, HARQ-ACK, and/or a scheduling request (SR), and may be divided into a plurality of PUCCHs according to a PUCCH transmission length.

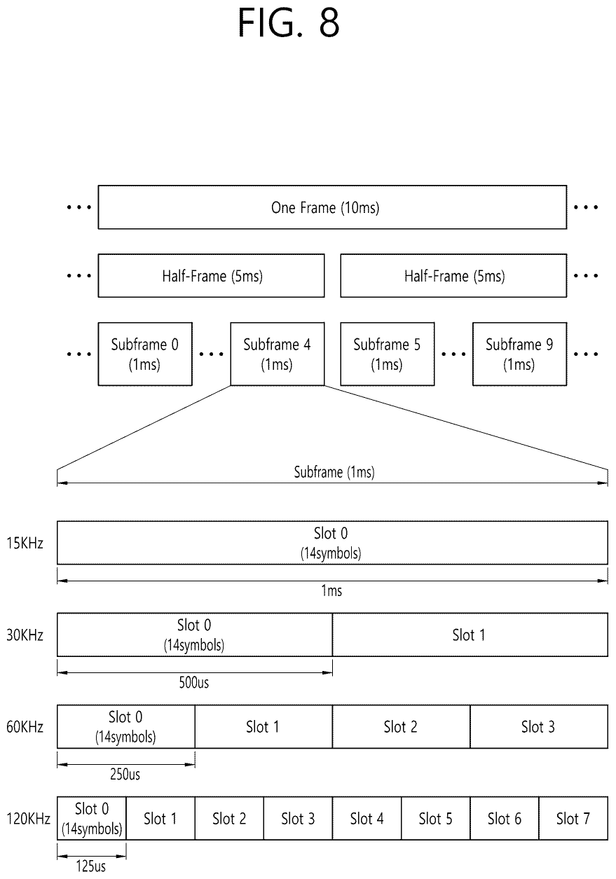

FIG. 8 shows a frame structure in a 3GPP-based wireless communication system.

The frame structure shown in FIG. 8 is purely exemplary, and the number of subframes, the number of slots, and/or the number of symbols in the frame may be variously changed. In a 3GPP-based wireless communication system. OFDM numerology (e.g., Sub-Carrier Spacing (SCS), Transmission Time Interval (TTI) period) may be set differently between a plurality of cells aggregated for one UE. For example, when the UE is set to different SCS for an aggregated cell, the (absolute time) duration of a time resource (e.g., subframe, slot, or TTI) including the same number of symbols may be different between aggregated cells. Here, the symbol may include an OFDM symbol (or a CP-OFDM symbol) and an SC-FDMA symbol (or a Discrete Fourier Transform-Spread-OFDM (DFT-s-OFDM) symbol).

Referring to FIG. 8, downlink and uplink transmission are configured in frames. Each frame may have a duration of, for example, T_{f}=10 ms. Each frame may consist of two half-frames, and the duration of each half-frame is 5 ms. Each half frame consists of 5 subframes, and the duration T_{sf} per subframe is 1 ms. Each subframe is divided into slots, and the number of slots in the subframe varies according to the subcarrier spacing. Each slot includes 14 or 12 OFDM symbols based on CP (Cyclic Prefix). In the normal CP, each slot includes 14 OFDM symbols, and in the extended CP, each slot includes 12 OFDM symbols. Numerology is based on an exponentially scalable subcarrier spacing Δf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for a normal CP according to the subcarrier spacing Δf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb} for the extended CP, the number of slots per frame N^{frame,u}ₛₗₒₜ, and the number of slots per subframe N^{subframe,u}ₛₗₒₜ according to the subcarrier spacing Δf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes a plurality of symbols (e.g., 14 or 12 symbols) in the time domain. For each numerology (e.g. subcarrier spacing) and carrier, a resource grid of N^{size,u}_{grid,x}*N^{RB}_{sc} subcarriers and N^{subframe,u}_{symb} OFDM symbols starting from Common Resource Block (CRB) N^{start,u}_{grid} indicated by higher layer signaling (e.g., RRC signaling) is defined. Here, N^{size,u}_{grid,x} is the number of resource blocks (RBs) in the resource grid, and the subscript x is DL for downlink and UL for uplink. N^{RB}_{sc} is the number of subcarriers per RB. In a 3GPP based wireless communication system. N^{RB}_{sc} is generally 12. There is one resource grid for a given antenna port p, subcarrier spacing configuration u, and transmission direction (DL or UL). The carrier bandwidth N^{size,u}_{grid} for the subcarrier spacing configuration u is given by a higher layer parameter (e.g., RRC parameter). Each element of the resource grid for the antenna port p and the subcarrier spacing configuration u is called a resource element (RE), and one complex symbol may be mapped to each RE. Each RE in the resource grid is uniquely identified by an index k in the frequency domain and an index l indicating a symbol position with respect to a reference point in the time domain.

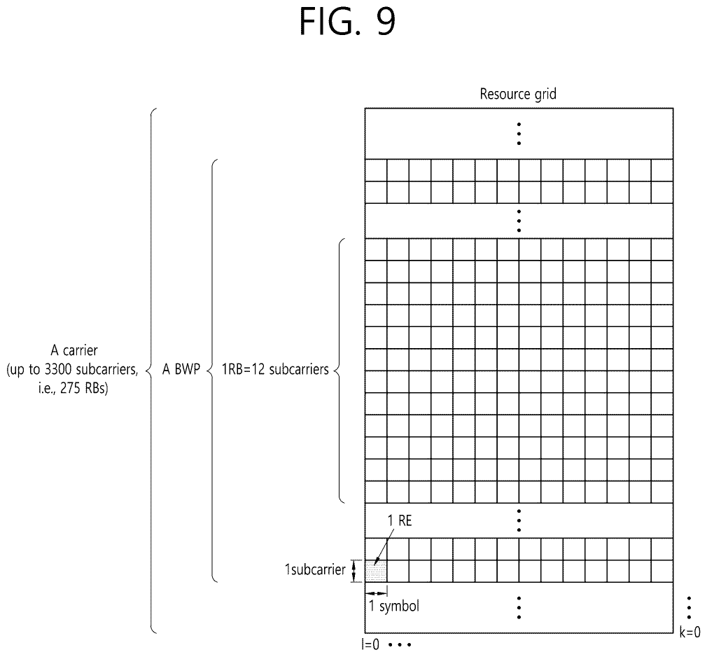

FIG. 9 illustrates the slot structure of a frame.

Referring to FIG. 9, a slot includes a plurality of symbols in the time domain. For example, in the case of a normal CP, one slot may include 14 symbols, but in the case of an extended CP, one slot may include 12 symbols. Alternatively, in the case of a normal CP, one slot may include 7 symbols, but in the case of an extended CP, one slot may include 6 symbols.

A carrier includes a plurality of subcarriers in the frequency domain. A resource block (RB) may be defined as a plurality of (e.g., 12) consecutive subcarriers in the frequency domain. BWP (Bandwidth Part) may be defined as a plurality of consecutive (P)RB ((Physical) Resource Block) in the frequency domain, and may correspond to one numerology (e.g., SCS, CP length, etc.). A carrier may include a maximum of N (e.g., 5) BWPs. Data communication may be performed through the activated BWP. Each element may be referred to as a resource element (RE) in the resource grid, and one complex symbol may be mapped.

In a 3GPP-based wireless communication system, an RB is defined as 12 consecutive subcarriers in a frequency domain. In the 3GPP NR system, the RB is divided into a CRB and a physical resource block (PRB). CRBs are numbered in increasing direction from 0) in the frequency domain for the subcarrier spacing configuration u. The center of subcarrier 0) of CRB 0 for subcarrier spacing configuration u coincides with ‘point A’, which serves as a common reference point for the resource block grid. In the 3GPP NR system. PRBs are defined within a BandWidth Part (BWP) and are numbered from 0 to N^{size}_{BWP,i}−1. Here, i is the BWP number. The relationship between PRB n_{PRB} and CRB n_{CRB} of BWP i is as follows, n_{PRB}=n_{CRB}+N^{size}_{BWP,i}, where N^{size}_{BWP,i} is the CRB whose BWP starts with CRB 0 The BWP includes a plurality of consecutive RBs. A carrier may contain up to N (eg 5) BWPs. The UE may be configured with one or more BWPs on a given CC. Among the BWPs set in the UE, only one BWP may be activated at a time. Active BWP defines the operating bandwidth of the UE within the operating bandwidth of the cell.

In the PHY layer, the uplink transport channels UL-SCH and RACH (Random Access Channel) are mapped to physical channels PUSCH (Physical Uplink Shared Channel) and PRACH (Physical Random Access Channel), respectively, and downlink transport channels DL-SCH, BCH, and PCH are mapped to a Physical Downlink Shared Channel (PDSCH), a Physical Broadcast Channel (PBCH), and a PDSCH, respectively. In the PHY layer, Uplink Control Information (UCI) is mapped to a Physical Uplink Control Channel (PUCCH), Downlink Control Information (DCI) is mapped to a Physical Downlink Control Channel (PDCCH). A MAC PDU related to UL-SCH is transmitted by a UE through a PUSCH based on a UL grant, and a MAC PDU related to DL-SCH is transmitted by a BS through a PDSCH based on DL allocation.

The symbols/abbreviations/terms used in this specification are as follows.
BLER: Block Error Rate
CCE: Control Channel Element
DCI: Downlink Control Information
FDRA: Frequency Domain Resource Assignment
HARQ: Hybrid Automatic Repeat reQuest
LTE: Long-Term Evolution
MCS: Modulation and Coding Scheme
NDI: New Data Indicator
NR: New Radio
OFDM: Orthogonal Frequency Division Multiplexing
PDCCH: Physical Downlink Control Channel
PDSCH: Physical Downlink Shared Channel
PSCCH: Physical Sidelink Control Channel
PSSCH: Physical Sidelink Shared Channel
PUCCH: Physical Uplink Control Channel
PUSCH: Physical Uplink Shared Channel
QAM: Quadrature Amplitude Modulation
QoS: Quality of Service
QPSK: Quadrature Phase Shift Keying
RV: Redundancy Version
SCI: Sidelink Control Information
SCS: Sub-Carrier Spacing
TDRA: Time Domain Resource Assignment
TTI: Transmit Time Interval
UE: User Equipment

The present disclosure relates to a wireless transmission device and method for increasing the transmission reliability of signaling data transmitted together with user or application data in a wireless communication system.

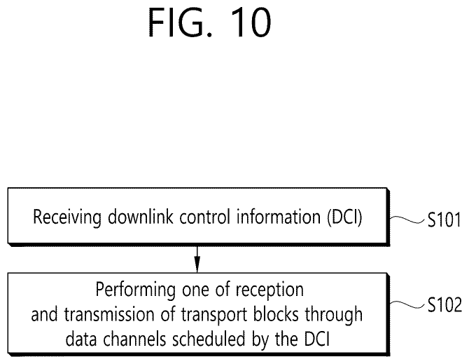

FIG. 10 illustrates UE operation according to base station scheduling.

Referring to FIG. 10, the UE receives downlink control information (DCI) (S101). For example, the UE may acquire the DCI by performing an attempt to detect PDCCH candidates in the configured search space (also referred to as blind decoding or blind detection). The DCI may be a DCI format for scheduling a PUSCH (e.g., DCI format 0_0, 0_1, etc.), a DCI format for scheduling a PDSCH (e.g., DCI format 1_0, 1_1, etc.), a DCI format for scheduling a PSSCH (e.g., DCI format 3_0, 3_1, etc.).

The UE performs either reception or transmission of transport blocks through a data channel (e.g., PDSCH, PUSCH, or PSSCH) scheduled by the DCI (S102). That is, the data channel may be a shared channel such as PDSCH, PUSCH, or PSSCH.

Information transmitted through DCI may include at least one of Frequency Domain Resource Assignment (FDRA), Time Domain Resource Assignment (TDRA), Modulation and Coding Scheme (MCS), New Data Indicator (NDI), Redundancy Version (RV), and Hybrid Automatic Repeat and reQuest Process Number (HARQ PN).

FDRA contains frequency resource information of scheduled PUSCHs. TDRA contains time resource information of scheduled PUSCHs.

MCS specifies the modulation and coding method.

Logical channels can be classified into two groups: control channels and traffic channels. The control channels are used only for control plane information transmission, and include the following channels:
1) BCCH (Broadcast Control Channel): A downlink channel for broadcasting system control information.
2) Paging Control Channel (PCCH): A downlink channel for carrying paging messages.
3) CCCH (Common Control Channel): A channel for transmitting control information between a UE and a network, and this channel is used by UEs that do not have an RRC connection with the network.
4) Dedicated Control Channel (DCCH): A point-to-point bidirectional channel for transmitting dedicated control information between a UE and a network, and is used by UEs that have an RRC connection.

The above traffic channel is used only for transmitting user plane information. DTCH (Dedicated Traffic Channel) is a point-to-point channel dedicated to one UE for transmitting user information. DTCH can exist in both uplink and downlink.

There are two types of MCS indices: those that include both modulation order and code rate information (hereinafter referred to as Type 1 MCS indices) and those that include only modulation order information (hereinafter referred to as Type 2 MCS indices).

The table below provides an example of a table containing MCS indices.

TABLE 5

| MCS index | Modulation Order | Target code | Spectral |
|---|---|---|---|
| I_{MCS} | Qₘ | Rate R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

For example, when QPSK, 16QAM, 64QAM, and 256QAM are supported in NR, as exemplified in Table 5 above, MCS indices 0 to 27 include both modulation order and code rate information and can be used for both initial transmission and retransmission. On the other hand, MCS indices 28 to 31 contain only modulation order information and can only be used for retransmission. That is, MCS indices 0 to 27 are Type 1 MCS indices, and MCS indices 28 to 31 are Type 2 MCS indices.

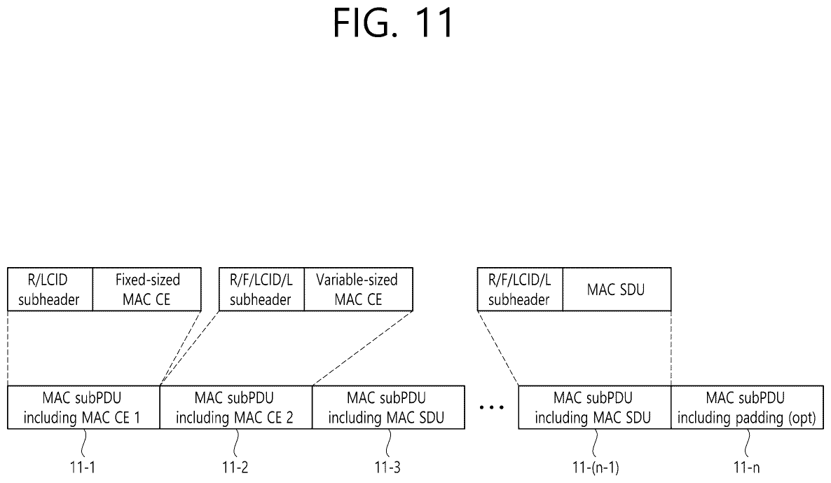

FIG. 11 illustrates a 5G NR downlink MAC protocol data unit (PDU).

Referring to FIG. 11, a MAC PDU may include one or more MAC sub-PDUs (subPDUs, 11-1, 11-2, 11-3, . . . , 11-(n−1), 11-n). Each MAC sub-PDU may consist of i) a MAC subheader and a MAC Control Element (CE), or ii) a MAC subheader and a MAC service data unit (SDU), or iii) a MAC subheader and zero or more bytes of padding.

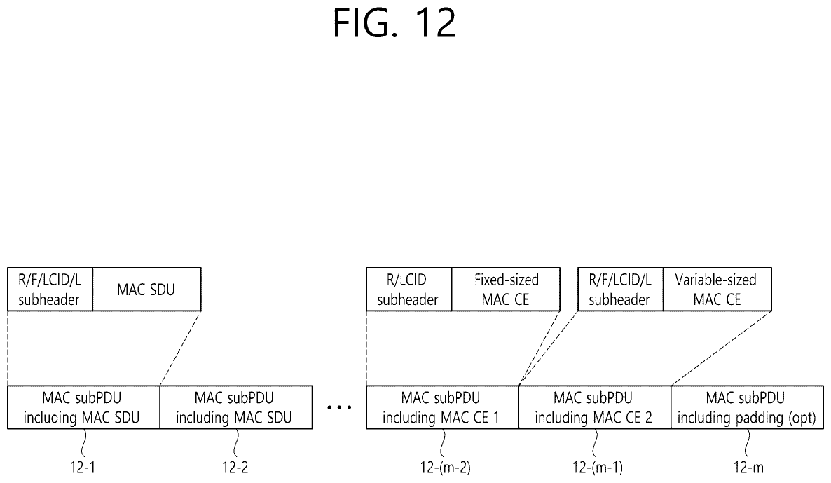

FIG. 12 illustrates a 5G NR uplink MAC PDU.

Referring to FIG. 12, a MAC PDU may include one or more MAC sub-PDUs (12-1, 12-2, . . . , 12-(m−2), 12-(m−1), 12-m). Each MAC sub-PDU may consist of i) a MAC subheader and a MAC Control Element (CE), or ii) a MAC subheader and a MAC SDU, or iii) a MAC subheader and zero or more bytes of padding.

In FIGS. 11 and 12, one MAC PDU can be transmitted through one Transport Block (TB) in the physical layer (PHY). Each transport block can be transmitted through a physical channel such as PDSCH or PUSCH after adding a CRC (cyclic redundancy check) and going through channel coding. Each transport block is applied with an appropriate modulation and coding scheme (MCS) depending on the required transmission quality (e.g., BLER, transmission delay time, etc.) and channel conditions.

The base station can transmit the MCS index and allocated radio resource information to the UE through downlink control information (DCI). The base station and the UE can calculate the size of the transport block (TBS) based on the MCS and allocated radio resource information.

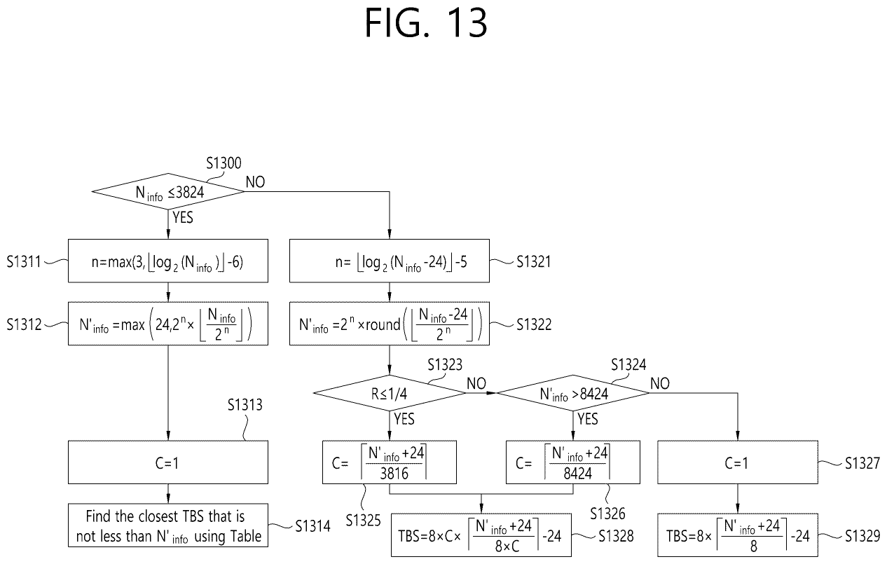

FIG. 13 illustrates a process for determining a Transport Block Size (TBS). The method of FIG. 13 can be applied to NR, and can also be partially/fully applied to the method of the present disclosure.

In FIG. 13, N_{info} can be obtained by Equation 1 as an unquantized intermediate variable. In Equation 1, N_{RE} is the number of allocated resource elements (REs), for example, the total number of REs allocated for PDSCH. R is the code rate, Qₘ is the modulation order, and v is the number of transmission layers. The code rate R and the modulation order Qₘ can be obtained from the MCS index.

$${N}_{info} = {N}_{RE} \times R \times {Q}_{m} \times v \qquad [ Equation 1 ]$$

Depending on whether N_{info} is less than or greater than 3824, the quantized intermediate number of information bits N′_{info} is determined in different ways. That is, when N_{info} is less than or equal to 3824, N′_{info} is determined according to S1311 and S1312. When N_{info} exceeds 3824, N′_{info} is determined according to S1321 and S1322.

When N_{info} is less than or equal to 3824, the number of code blocks C in the transport block is 1 (S1313), and TBS can be found by finding the closest TBS that is not less than N′_{info} (S1314) based on the following Table 6.

TABLE 6

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

If N_{info} exceeds 3824, the number of code blocks C in a transport block and the transport block size TBS are determined by considering whether the code rate R is less than or equal to ¼ and whether N′_{info} is greater than 8424 (S1323 to S1329).

Now, a wireless transmission device and method for efficiently ensuring transmission quality of signaling data when transmitting signaling data together with user data or application data in a wireless communication system are described. Here, signaling data may mean control information such as MAC CE (Control Element), for example. User data or application data may mean traffic data.

MAC CE transmits control information in the MAC layer. Base stations and UEs can transmit control information more quickly than higher layer signaling such as RRC using MAC CE. MAC CE can carry more and different control information compared to physical layer signaling, such as downlink control information (DCI). As the need to provide increasingly diverse functions with lower delay values in wireless communication systems increases, the need for base stations and UEs to quickly exchange various types of control information is also increasing. Accordingly, the purpose and importance of MAC CE are also increasing, and this trend is expected to continue in next-generation wireless communication systems such as 6G.

As seen in FIGS. 11 and 12, in 5G NR, MAC CE is created as MAC PDU and transmitted together with traffic data of higher layers. One MAC PDU is composed of one Transport Block (TB) and transmitted in the physical layer. Since one MCS (Modulation and Coding Scheme) is applied to one transport block and transmitted. MAC CE and traffic data have the same transmission quality in the physical layer. That is, in the conventional technology, two pieces of information with different importance, that is, MAC CE and traffic data, have a structure in which they are transmitted with the same transmission quality.

Since the MAC CE carries control information, if an error occurs in the transport block containing the MAC CE, the operation of the base station and UE may be delayed, leading to system performance degradation such as reduced data rate or increased transmission delay.

The MCS can be lowered to reduce the transmission error of the transport block containing the MAC CE. However, since the MAC CE typically occupies a small portion of a transport block, lowering the MCS to increase the transmission reliability of the MAC CE may cause data other than the MAC CE that occupies the majority of the transport block to be transmitted at a lower MCS, resulting in inefficient use of radio resources.

The present disclosure describes a wireless transmission apparatus and method that, when transmitting a MAC CE, distinguishes a first transport block containing the MAC CE from a second transport block that does not contain the MAC CE, and then applies different MCSs to the first and second transport blocks for transmission, thereby increasing the transmission reliability of the MAC CE while increasing the efficiency of wireless resource use.

Below, the present disclosure is described in more detail.

In wireless communication systems such as 4G LTE and 5G NR, as the size of the transport block (TB) increases, a single transport block can be divided into multiple code blocks (CB) for transmission. In most cases, the MAC CE is likely to be transmitted in a single code block because the amount of data in the MAC CE is not large. By transmitting the code block containing the MAC CE and the rest of the code blocks at different MCSs, it is possible to increase the probability of successful transmission of the MAC CE while not significantly reducing the efficiency of radio resources. For example, if only the code block containing the MAC CE is transmitted at a lower MCS than the rest of the code blocks, the transmission reliability of the MAC CE can be increased.

Typically, the physical layers of the base station and UE check the CRC for each transport block to determine if there are any errors, and only when there are no errors can the MAC process the data. Therefore, within one transport block, if a code block including a MAC CE is received without error but an error occurs in the remaining code blocks, data cannot be processed for the entire transport block, and as a result, processing of the MAC CE may be delayed. This problem can be solved by separating the transport block being transmitted, such as separating them into code blocks including the MAC CE and the remaining code blocks.

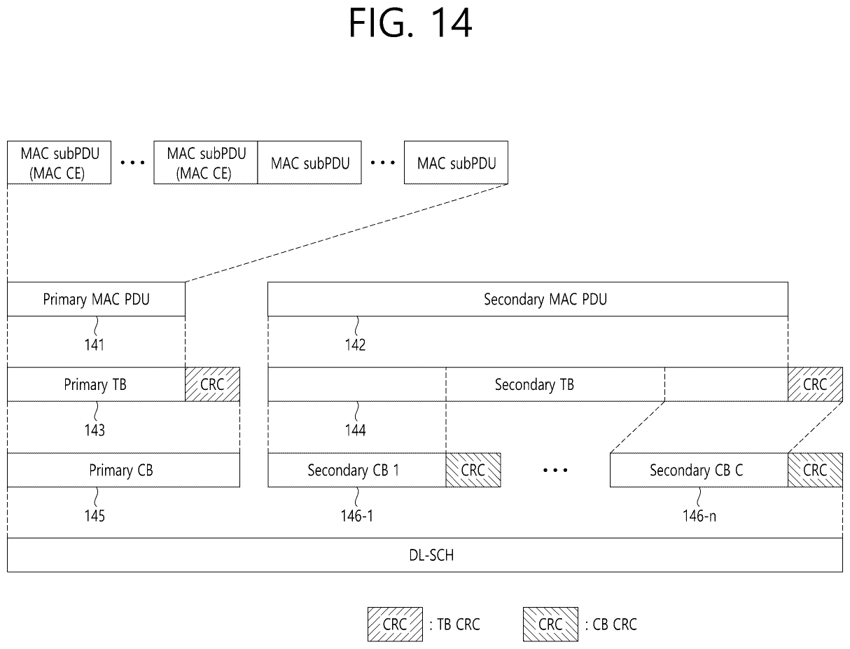

FIG. 14 illustrates a downlink transmission structure for improving MAC CE transmission reliability.

Referring to FIG. 14, when transmitting MAC CE and other data through multiple code blocks in downlink transmission of 5G NR, the code block including the MAC CE can be processed independently regardless of errors in the remaining code blocks, and different MCSs can be applied to the code block including the MAC CE and the remaining code blocks for transmission.

The MAC may comprise MAC PDUs, including a first MAC PDU (141) that includes a MAC CE and a second MAC PDU (142) that does not include a MAC CE. At the physical layer, the first MAC PDU 141 may be mapped to a primary transport block (Primary TB, PTB, 143) and the second MAC PDU 142 may be mapped to a secondary transport block (Secondary TB. STB, 144). The first transport block 143 may comprise one code block 145, and the second transport block 144 may comprise one or more code blocks 146-1, . . . , 146-n. The two transport blocks 143, 144 may be transmitted over one downlink shared channel (DL-SCH).

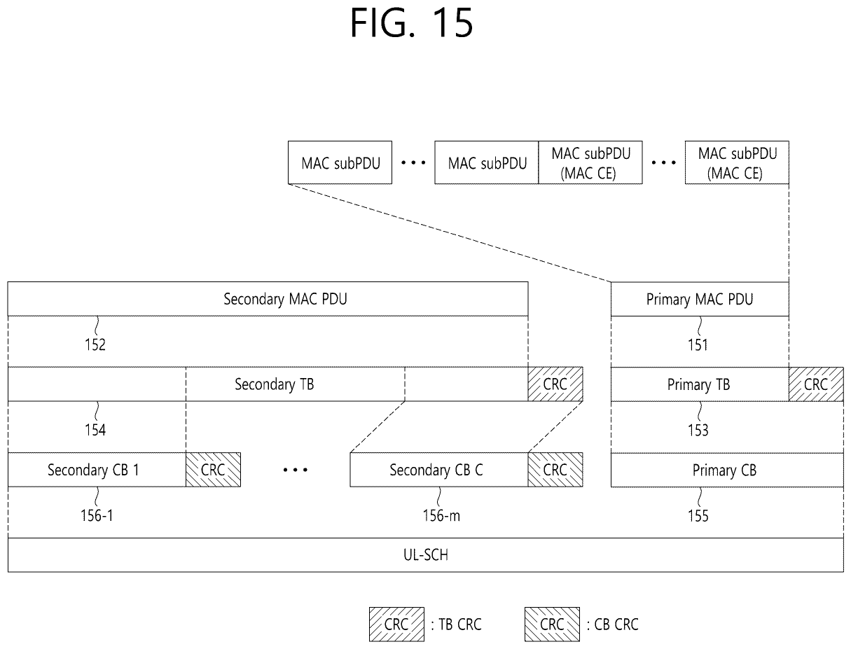

FIG. 15 illustrates an uplink transmission structure for improving MAC CE transmission reliability.

Referring to FIG. 15, when transmitting MAC CE and other data through multiple code blocks in uplink transmission of 5G NR, the code block including the MAC CE can be processed independently regardless of errors in the remaining code blocks, and different MCSs can be applied to the code block including the MAC CE and the remaining code blocks for transmission.

The MAC may comprise MAC PDUs, including a first MAC PDU (Primary MAC PDU, 151) containing a MAC CE and a second MAC PDU (Secondary MAC PDU. 152) not containing a MAC CE. At the physical layer, the primary MAC PDU 151 may be mapped to a primary transport block (primary TB. PTB. 153) and the secondary MAC PDU 152 may be mapped to a secondary transport block (secondary TB. STB. 154). The first transport block 153 may comprise one code block 155, and the second transport block 154 may comprise one or more code blocks 156-1, . . . 156-m. The two transport blocks 153, 154 may be transmitted over one uplink shared channel (UL-SCH). In the uplink of 5G NR, since the MAC CE is transmitted last, the second transport block can be physically transmitted first and the first transport block can be transmitted later.

In FIGS. 14 and 15, the first transport block is exemplified as including a MAC CE and the second transport block does not include a MAC CE, but this is not a limitation and need not be the case. For example, the first transport block may not include a MAC CE and may include specific data that requires higher reliability than the remaining data. That is, both the first transport block and the second transport block may not include MAC CE, and the first transport block may include data with high importance.

As another example, when transmitting multiple MAC CEs, if all MAC CEs cannot be transmitted with only the first transport block, some lower priority MAC CEs may be transmitted through the second transport block. That is, both the first transport block and the second transport block may include MAC CEs.

Since two transport blocks should be transmitted with different MCSs applied, the base station should inform the UE of two MCS information. MCS includes modulation order information, and the modulation order should be applied per RE unit. The total REs allocated to one UE should be divided and allocated for two transport blocks. The size of each transport block can be determined according to the number of REs allocated to each transport block.

The base station and the UE should be able to allocate the same RE to each transport block and determine the same size of each transport block. Directly conveying the number of REs allocated to each transport block or the size of each transport block in the DCI can significantly increase the number of bits in the DCI. Therefore, a method is needed whereby a base station can convey to a UE the number of MCSs and REs transmitted in each transport block and the size of the transport block while minimizing the increase in the bit size of the DCI.

### <Method for Transmitting Two MCS Index Information>

In general, the lower the MCS, i.e., the lower the modulation order and the lower the code rate, the lower the BLER. Therefore, the first transport block should be transmitted with a lower or equal MCS index than the second transport block. If the MCS index of the first transport block is I_{MCS}^{p}, the MCS index of the second transport block is I_{MCS}^{s}, and the difference between the two MCS indexes is O_{MCS}^{s} (≥0), their relationship can be expressed by Equation 2.

$${I}_{MCS}^{s} = {I}_{MCS}^{p} + {O}_{MCS}^{s} \qquad [ Equation 2 ]$$

To transmit two MCS indices as is through DCI, twice as many bits are required as are required for one MCS index. For example, to directly convey two MCS indices of LTE or NR, which are defined as values from 0 to 31, 10 bits are required. On the other hand, the number of DCI bits can be reduced if the first MCS index of the first transport block is carried in its entirety, and the second MCS index of the second transport block is carried with the difference from the first MCS index, i.e., O_{MCS}^{s}, but the range of O_{MCS}^{s} is limited. For example, if the range of O_{MCS}^{s} is limited to values from 0 to 3 or less, both I_{MCS}^{p} and I_{MCS}^{s} can be carried by only 7 bits.

There are two types of MCS indices: those that include both modulation order and code rate information (hereinafter referred to as Type 1 MCS indices) and those that include only modulation order information (hereinafter referred to as Type 2 MCS indices).

For example, when supporting QPSK, 16QAM, 64QAM, and 256QAM in NR, MCS indices 0 to 27 include both modulation order and code rate information and can be used for both initial transmission and retransmission. On the other hand, MCS indices 28 to 31 include only modulation order information and can be used only for retransmission. The MCS index information (of the two transport blocks) transmitted through DCI can always be the same type of MCS indices. For example, if the NR supports QPSK, 16QAM, 64QAM, and 256QAM, an O_{MCS}^{s} of 2 or more when the I_{MCS}^{p} is 26 would result in an I_{MCS}^{s} of 28 or more, in which case the I_{MCS}^{p} would be the first type of MCS index and the I_{MCS}^{s} would be the second type of MCS index, making them different types of MCS indexes, and to avoid this, the O_{MCS}^{s} may be restricted to have values of 0 or 1 only.

### <Method for Determining the Transport Block Size (TBS)>

The UE can obtain the code rate and modulation order of each transport block from the first MCS index I_{MCS}^{p} of the first transport block and the second MCS index I_{MCS}^{s} of the second transport block received from the base station via DCI.

In addition, the base station can transmit to the UE, through DCI, the number of allocated total resource elements (REs), the number of transmission layers, etc. Since the modulation order should be applied per resource element (RE), the allocated total REs can be considered to be divided and allocated to each transport block. Knowing the number of REs allocated to each transport block, the size of each transport block (TBS) and the number of code blocks (C) can be obtained by the procedure of FIG. 13.

Let the total number of REs allocated to the UE be N_{RE}, the number of REs allocated to the first transport block be N_{RE}^{p}, and the number of REs allocated to the second transport block be N_{RE}^{s}. Then, the relationship between them can be expressed by Equation 3.

$${N}_{RE} = {N}_{RE}^{p} + {N}_{RE}^{s} \qquad [ Equation 3 ]$$

When the code rate of the first transport block is R^{p}, the modulation order is Qₘ^{p}, the code rate of the second transport block is R^{s}, the modulation order is Qₘ^{s}, and the number of transmission layers is v, the intermediate value N_{info} (unquantized intermediate variable) for determining the size of the entire transport block can be expressed as in Equation 4.

$${N}_{info} = ( {N}_{RE}^{p} {R}^{p} {Q}_{m}^{p} + {N}_{RE}^{s} {R}^{s} {Q}_{m}^{s} ) v \qquad [ Equation 4 ]$$

If N_{RE}^{p}R^{p}Qₘ^{p}v is k, N_{RE}^{s} can be expressed as in Equation 5.

$${N}_{R E}^{s} = {N}_{R E} - \frac{k}{{R}^{p} {Q}_{m}^{p} v} \qquad [ Equation 5 ]$$

If the maximum size of a code block is K_{CB}, the range of k is K_{CB}/2<k≤K_{CB}.

By substituting Equation 5 into Equation 4 and expressing N_{info} as a function of k, n_{info}(k), Equation 4 can be expressed as Equation 6.

$${n}_{info} ( k ) = k + ( {N}_{RE} {R}^{s} {Q}_{m}^{s} v - \frac{{R}^{s} {Q}_{m}^{s}}{{R}^{p} {Q}_{m}^{p}} k ) = ( 1 - \frac{{R}^{s} {Q}_{m}^{s}}{{R}^{p} {Q}_{m}^{p}} ) k + {N}_{RE} {R}^{s} {Q}_{m}^{s} v \qquad [ Equation 6 ]$$

In general, channel codes such as LDPC (low-density parity-check) codes and Turbo codes have larger coding gains as the code block size increases. Therefore, when dividing a transport block into multiple code blocks, it is advantageous in terms of performance to divide the code blocks so that their size is maximized. When the maximum size of a code block is K_{CB}, the number of code blocks n_{CB}(k) can be expressed as in Equation 7.

$${n}_{CB} ( k ) = \frac{{n}_{info} ( k )}{{K}_{CB}} = ( 1 - \frac{{R}^{s} {Q}_{m}^{s}}{{R}^{p} {Q}_{m}^{p}} ) \frac{k}{{K}_{CB}} + \frac{{N}_{RE} {R}^{s} {Q}_{m}^{s} v}{{K}_{CB}} \qquad [ Equation 7 ]$$

When the first MCS index of the first transport block is smaller than the second MCS index of the second transport block, the number of code blocks n_{CB}(k) in Equation 7 becomes minimum when k=K_{CB} because R^{p}Qₘ^{p} is smaller than R^{s}Qₘ^{s}. Since the number of code blocks should be an integer, the number of code blocks N_{CB} can be expressed as in Equation 8.

$${{N}_{CB} = ⌈ \frac{{n}_{info} ( k )}{{K}_{CB}} \vert}_{k = {K}_{CB}} ⌉ = ⌈ ( 1 - \frac{{R}^{s} {Q}_{m}^{s}}{{R}^{p} {Q}_{m}^{p}} ) + \frac{{N}_{RE} {R}^{s} {Q}_{m}^{s} v}{{K}_{CB}} ⌉ \qquad [ Equation 8 ]$$

If the first transport block is transmitted as one code block (i.e., the first transport block consists of only one code block), the second transport block is transmitted as (N_{CB}−1) code blocks (i.e., the second transport block consists of (N_{CB}−1) code block(s)). Therefore, the relationship between N_{RE}^{p} and N_{CB} can be expressed as in Equation 9.

$$1 \text{:} ( {N}_{C B} - 1 ) ≅ {N}_{R E}^{p} {R}^{p} {Q}_{m}^{p} v : ( {N}_{R E} - {N}_{R E}^{p} ) {R}^{s} {Q}_{m}^{s} v \qquad [ Equation 9 ]$$

Since N_{RE}^{p} should be an integer, N_{RE}^{p} can be calculated as in Equation 10.

$${N}_{R E}^{p} = ⌈ \frac{{N}_{R E} {R}^{S} {Q}_{m}^{s}}{( {N}_{C B} - 1 ) {R}^{p} {Q}_{m}^{p} + {R}^{s} {Q}_{m}^{s}} ⌉ \qquad [ Equation 10 ]$$

N_{RE}^{s} can be obtained from Equation 3 as in Equation 11.

$${N}_{R E}^{s} = {N}_{R E} - {N}_{R E}^{p} \qquad [ Equation 11 ]$$

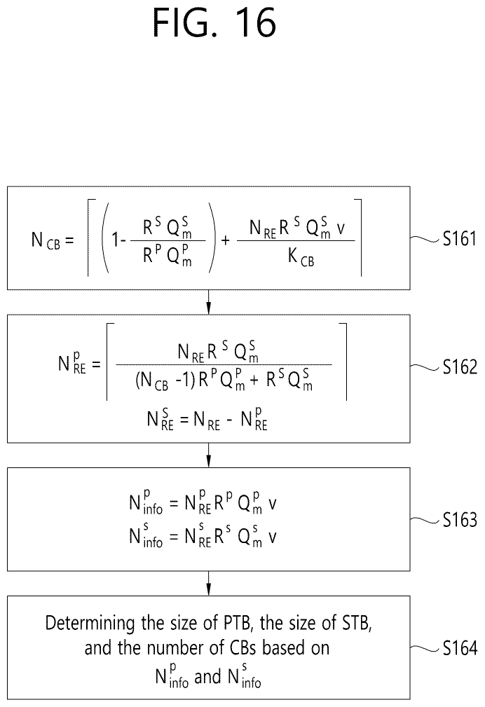

FIG. 16 shows an example of determining the size of a first transport block (PTB) and the size of a second transport block (STB).

FIG. 16 is an example of a procedure for determining the sizes of the first transport block and the second transport block based on the aforementioned equations 8, 10, and 11.

That is, S161 is based on the aforementioned equation 8, and S162 is based on equations 10 and 11. Through this process, N_{info}^{p} and N_{info}^{s} are obtained in S163, and the size of PTB, the size of STB, and the number of CBs are determined in S164 based on N_{info}^{p} and N_{info}^{s}.

However, there may be a problem in directly applying the procedures of FIG. 16 to the 5G NR standard. In 5G NR, the maximum size of the code block K_{CB} may vary depending on the code rate, etc. In addition, in the process of calculating the size of the transport block and the number of code blocks, N_{info} is not used as is, but rather goes through quantization (e.g., using the quantized intermediate number N′_{info}), so if this is not taken into account, the desired results may not be obtained.

In the NR standard, the maximum code block size K_{CB} varies depending on the LDPC base graph. For example, the K_{CB} of LDPC base graph 1 is 8448 and the K_{CB} of LDPC base graph 2 is 3840. Hereinafter, the K_{CB} of LDPC base graph I can be denoted as K_{CB}^{BG1}, and the K_{CB} of LDPC base graph 2 can be denoted as K_{CB}^{BG2}. The LDPC base graph can be determined by the code rate and the size of the transport block.

When the code rate R^{p} of the first transport block is ¼ or less, the maximum code block size of the first transport block is K_{CB}^{BG2}, i.e., 3840. In the NR standard, when the transport block size is 3824 or less, the CRC length of the transport block is 16, and when it exceeds 3824, it is 24. Since the first transport block should be transmitted as one code block (i.e., the first transport block contains only one code block), the maximum size of the first transport block is 3824. In FIG. 13, Equation 12 should be satisfied in order for the first transport block to be transmitted as one code block.

$${N}_{info}^{p} = {N}_{R E}^{p} {R}^{p} {Q}_{m}^{p} v \leq 3824 \qquad [ Equation 12 ]$$

$${N}_{R E}^{p} \leq \frac{3824}{{R}^{p} {Q}_{m}^{p} v}$$

Therefore, the maximum number of REs allocated to the first transport block, N_{RE,max}^{p}, can be expressed as in Equation 13.

$${N}_{RE , max}^{p} = ⌊ \frac{3824}{{R}^{p} {Q}_{m}^{p} v} ⌋ \qquad [ Equation 13 ]$$

If N_{RE} is less than or equal to N_{RE,max}^{p}, all REs are allocated to the first transport block, and the second transport block can be considered not to be transmitted. That is, N_{RE}^{p} can be equal to N_{RE}, and N_{RE}^{s} can be 0. In this case, all data is transmitted through the first transport block and the second transport block may not be transmitted.

When N_{RE} is greater than N_{RE,max}^{p}, the number of REs allocated to the first transport block is maximum, the number N_{RE}^{s} of REs allocated to the second transport block and N_{info}^{s} for determining the size of the second transport block are minimum, and can be expressed as in Equations 14 and 15.

$${N}_{RE , min}^{s} = {N}_{R E} - ⌊ \frac{3824}{{R}^{p} {Q}_{m}^{p} v} ⌋ \qquad [ Equation 14 ]$$

$${N}_{info , min}^{s} = ( {N}_{R E} - ⌊ \frac{3824}{R P {Q}_{m}^{p} v} ⌋ ) {R}^{s} {Q}_{m}^{s} v \qquad [ Equation 15 ]$$

If N_{info,min}^{s} is less than or equal to 3824, the second transport block can be transmitted as one code block. Therefore, the total number of code blocks N_{CB} becomes 2. If N_{info,min}^{s} exceeds 3824, N_{CB} can be calculated by Equation 16.

In Equation 16, L_{CRC}^{STB} represents the CRC length of the second transport block, L_{CRC}^{CB} represents the CRC length of the code block, and both L_{CRC}^{STB} and L_{CRC}^{CB} are 24. K_{CB} represents the maximum code block size (length), and when the code rate R^{s} of the second transport block is ¼ or less, it is K_{CB}^{BG2} (=3840), and when it exceeds ¼, it is K_{CB}^{BG1} (=8448).

$${N}_{CB} = ⌈ 1 + \frac{{N}_{info , min}^{s} + {L}_{CRC}^{STB}}{{K}_{CB} - {L}_{CRC}^{CB}} ⌉ \qquad [ Equation 16 ]$$

After obtaining the N_{CB} by Equation 16, the number of REs allocated to the first transport block, N_{RE}^{p}, and the number of REs allocated to the second transport block, N_{RE}^{s}, can be obtained by Equations 17 and 11, respectively.

$${N}_{R E}^{p} = min ( ⌊ \frac{3824}{{R}^{p} {Q}_{m}^{p} v} ⌋ , ⌈ \frac{{N}_{R E} {R}^{s} {Q}_{m}^{s}}{( {N}_{C B} - 1 ) {R}^{p} {Q}_{m}^{p} + {R}^{s} {Q}_{m}^{s}} ⌉ ) \qquad [ Equation 17 ]$$

If the code rate R^{p} of the first transport block exceeds ¼, the maximum code block size of the first transport block becomes K_{CB}^{BG1}, i.e., 8448. In the NR standard, if the transport block size exceeds 3824, the CRC length of the transport block is 24. In order for the first transport block to be transmitted as one code block, the size of the transport block should be 8424 or less. In FIG. 13, in order for the transport block to be transmitted as one code block and its size to be 8424 or less, N_{info} should be 8343 or less. Therefore, the maximum number of REs allocated to the first transport block, N_{RE,max}^{p}, can be expressed as in Equation 18.

$${N}_{RE , max}^{p} = ⌊ \frac{8343}{{R}^{p} {Q}_{m}^{p} v} ⌋ \qquad [ Equation 18 ]$$

If N_{RE} is less than or equal to N_{RE,max}^{p}, all REs are allocated to the first transport block, and the second transport block may be considered not to be transmitted. That is, N_{RE}^{p} may be equal to N_{RE}, and N_{RE}^{s} may be 0. In this case, all data may be transmitted in the first transport block, and the second transport block may not be transmitted.

When N_{RE} is greater than N_{RE,max}^{p}, N_{info}^{s} for determining the size of the second transport block is minimum when the number of REs allocated to the first transport block is maximum, and can be expressed as in Equation 19.

$${N}_{info , min}^{s} = ( {N}_{R E} - ⌊ \frac{8343}{{R}^{p} {Q}_{m}^{p} v} ⌋ ) {R}^{s} {Q}_{m}^{s} v \qquad [ Equation 19 ]$$

The number of total code blocks N_{CB} can be calculated by Equation 16. The number of REs allocated to the first transport block N_{RE}^{p} and the number of REs allocated to the second transport block N_{RE}^{s} can be obtained by Equations 20 and 11, respectively.

$${N}_{R E}^{p} = min ( ⌊ \frac{8343}{{R}^{p} {Q}_{m}^{p} v} ⌋ , ⌈ \frac{{N}_{R E} {R}^{s} {Q}_{m}^{s}}{( {N}_{C B} - 1 ) {R}^{p} {Q}_{m}^{p} + {R}^{s} {Q}_{m}^{s}} ⌉ ) \qquad [ Equation 20 ]$$

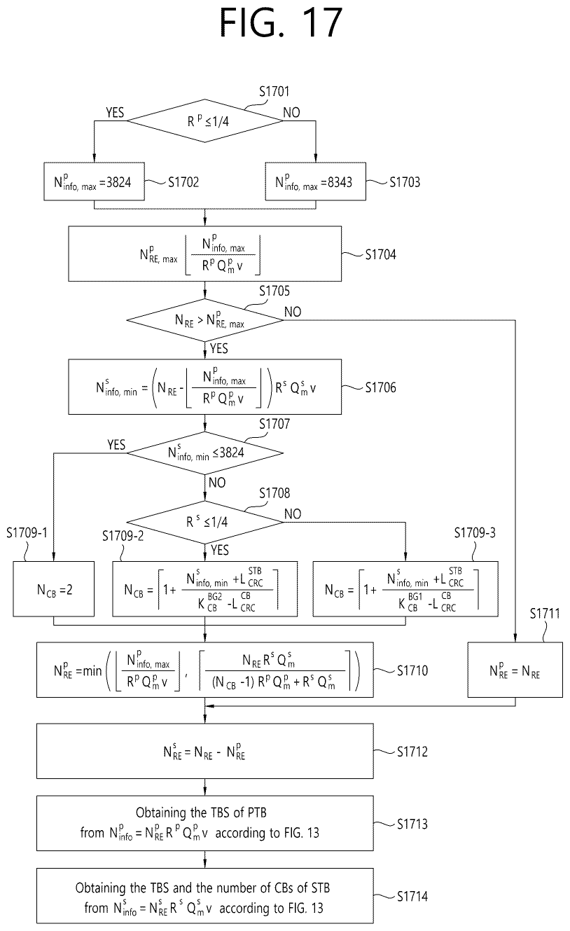

FIG. 17 is a schematic diagram of the procedure described in Equations 12 through 20.

In S1701, it is determined whether R^{p} is less than or equal to ¼. Based on the determination, the values of N_{info,max}^{p} are determined (S1702, S1703). In S1704, N_{RE,max}^{p} is determined. After that, N_{RE} and N_{RE,max}^{p} are compared (S1705), and N_{info,min}^{s} (S1706) or N_{RE}^{p} is determined based on the result (S1711). It is determined whether N_{info,min}^{s} is less than or equal to 3824 (S1707), and if so, N_{CB} is determined to be 2 (S1709-1). If not, it is determined whether R^{s} is less than or equal to ¼ (S1708), and N_{CB} is determined accordingly (S1709-2, S1709-3).

After that, N_{RE}^{p} is determined in S1710, and N_{RE}^{s} is determined in S1712.

In S1713, N_{info}^{p}=N_{RE}^{p}R^{p}Qₘ^{p}v is substituted into N_{info} of FIG. 13 to obtain the size of PTB, and in S1714, N_{info}^{s}=N_{RE}^{s}R^{s}Qₘ^{s}v is substituted into N_{info} of FIG. 13 to obtain the size of STB and the number of code blocks.

The number of N_{CB} determined based on equation 16 and the total number of code blocks determined in FIG. 17 (the sum of the number of code blocks of the first transport block and the number of code blocks of the second transport block) may not match.

There are two reasons for this. First, the number of REs N_{RE}^{p} allocated to the first transport block by Equations 17 and 20 is reduced compared to the maximum number of REs N_{RE,max}^{p} calculated by Equations 13 and 18. Therefore, the number of REs allocated to the second transport block increases, and N_{info}^{s} becomes larger than N_{info,min}^{s}, so the number of code blocks of the second transport block can increase. Second, this is because the quantization process of FIG. 13 is not considered in Equation 16.

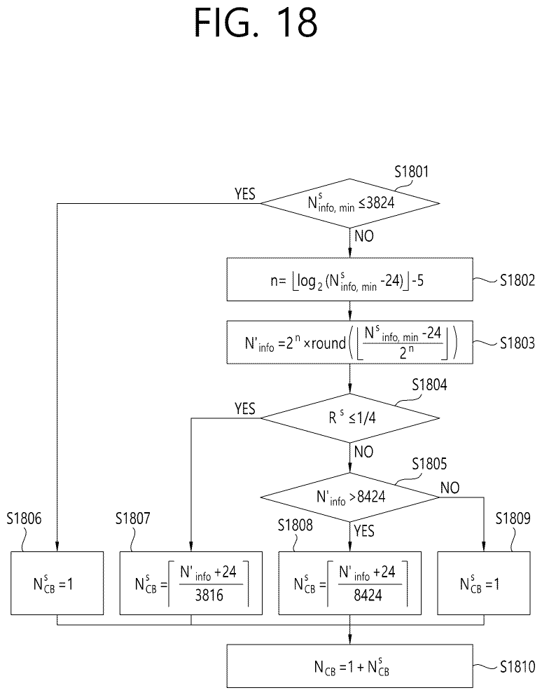

FIG. 18 illustrates a procedure for reducing the error between the N_{CB} and the final number of code blocks by applying the procedure for obtaining the number of code blocks in FIG. 13 when obtaining the N_{CB}.

N_{info,min}^{s} is a value calculated by Equation 15 or Equation 19. It is determined whether N_{info,min}^{s} is less than or equal to 3824 (S1801), and if so, N_{CB}^{s}=1 (S1806), and if not, n (S1802) and N′_{info} (S1803) are determined. Determine whether R^{s} is less than ¼ (S1804), and if so, determine NCBS according to S1807: otherwise, determine whether N′_{info} is greater than 8424 (S1805). Determine NCBS according to that determination (S1808, S1809). N_{CB} can be obtained by calculating the number of code blocks NCBS of the expected second transport block and adding I to the number of code blocks of the first transport block (S1810).

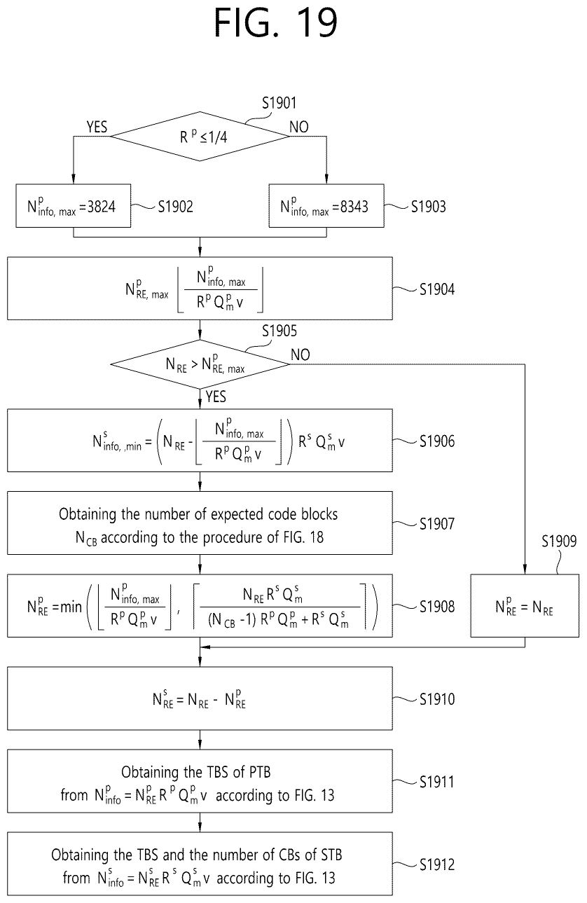

When the N_{CB} is obtained according to the procedure of FIG. 18, the procedure of FIG. 17 can be expressed as FIG. 19.

FIG. 19 illustrates a procedure for obtaining the size of PTB, the size of STB, and the number of CBs.

Referring to FIG. 19, in S1901, it is determined whether R^{p} is less than ¼. Based on the determination, the value of N_{info,max}^{p} is determined as one of 3824 and 8343 (S1902, S1903). In S1904, N_{RE,max}^{p} is determined. After that, N_{RE} and N_{RE,max}^{p} are compared (S1905), and N_{info,min}^{s} (S1906) or N_{RE}^{p} is determined based on the result (S1909). After obtaining N_{info,min}^{s}, the number of expected code blocks N_{CB} is obtained according to the procedure of FIG. 18 (S1907), and N_{RE}^{p} is determined accordingly (S1908). In S1910, N_{RE}^{s} is determined.

In S1911, N_{info}^{p}=N_{RE}^{p}R^{p}Qₘ^{p}v is substituted into N_{info} of FIG. 13 to obtain the size of PTB, and in S1912, N_{info}^{s}=N_{RE}^{s}R^{s}Qₘ^{s}v is substituted into N_{info} of FIG. 13 to obtain the size of STB and the number of code blocks.

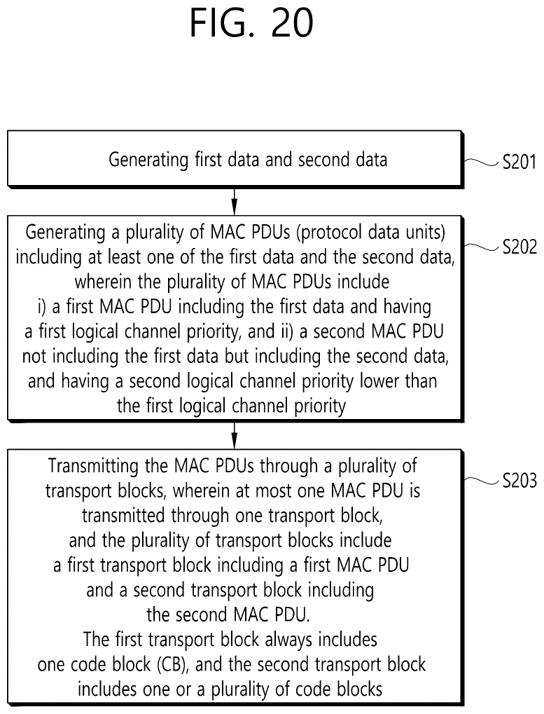

FIG. 20 illustrates a method for transmitting a transport block of a device in a wireless communication system.

Referring to FIG. 20, a device (e.g., a UE) generates first data and second data (S201).

The device generates a plurality of MAC PDUs (protocol data units) including at least one of the first data and the second data. The plurality of MAC PDUs include i) a first MAC PDU including the first data and having a first logical channel priority, and ii) a second MAC PDU not including the first data but including the second data, and having a second logical channel priority lower than the first logical channel priority (S202).

The device transmits the MAC PDUs through a plurality of transport blocks, wherein at most one MAC PDU is transmitted through one transport block, and the plurality of transport blocks include a first transport block including a first MAC PDU and a second transport block including the second MAC PDU. At this time, the first transport block always includes one code block (CB), and the second transport block includes one or a plurality of code blocks (S203).

For example, the first data may be data having a relatively high priority (importance), such as a media access control (MAC) control element (CE). The second data may be data having a relatively low priority (importance) compared to the first data, such as traffic data.

The device generates a plurality of MAC PDUs (protocol data units) including at least one of the first data (e.g., MAC CE) and the second data (e.g., traffic data), and transmits the MAC PDUs through a plurality of transport blocks, wherein at most one MAC PDU can be transmitted through one transport block.

A MAC PDU consists of one or more MAC subPDUs, and each MAC subPDU can consist of one of the following:
i) MAC subheader (including padding), ii) MAC subheader and MAC SDU, iii) MAC subheader and MAC CE, iv) MAC subheader and padding.

The size of a MAC SDU can vary. Each MAC subheader can correspond to a MAC SDU, a MAC CE, or padding.

For example, a first modulation and coding scheme (MCS) may be applied to the first transport block, and a second MCS may be applied to the second transport block. Here, the first MCS and the second MCS may be independent (or different) MCSs.

The first transport block may be the aforementioned PTB, and the second transport block may be the aforementioned STB.

The first MCS index indicating the first MCS may be less than or equal to the second MCS index indicating the second MCS.

The device can receive downlink control information (DCI), wherein the DCI can indicate a first MCS index indicating the first MCS and a second MCS index indicating the second MCS. For example, the DCI can indicate i) a value of the first MCS index and ii) a difference between a value of the first MCS index and a value of the second MCS index.

The above DCI can inform the number of total resource elements allocated to the UE and the number of transmission layers.

The device can obtain a code rate and a modulation order of a transport block based on at least one of the first MCS index and the second MCS index.

The device can calculate the size of the first transport block, the size of the second transport block, and the number of code blocks included in the second transport block based on the first MCS index indicating the first MCS, the second MCS index indicating the second MCS, the number of total resource elements, and the number of transmission layers. This has been described in detail with reference to FIGS. 13 to 19.

For example, the device estimates the number of code blocks contained in the first transport block and the minimum number of code blocks contained in the second transport block, and allocates the total resource elements to the first transport block and the second transport block based on the estimated number of code blocks contained in the first transport block and the minimum number of code blocks contained in the second transport block, the first MCS and the second MCS.

And, based on the number of resource elements allocated to each transport block and the number of the transmission layers, the size of the first transport block, the size of the second transport block, and the number of code blocks included in the second transport block may be calculated.

The method described in FIG. 20 enables the two groups of data to be transmitted to independent (or different) MCSs when a MAC CE (or a small amount of specific data that requires high transmission reliability) is transmitted along with a large amount of data that requires relatively low transmission reliability. This allows the MAC CE to increase the transmission reliability of the MAC to increase the reliability and performance of the system, while maintaining the efficiency of resource use when transmitting large amounts of data.

In addition, when notifying the different MCSs through DCI, the increase in the number of bits of DCI can be minimized.

In the following description and drawings, for convenience of explanation, MAC CE is exemplified as a specific example of first data, and traffic data is exemplified as a specific example of second data, but this is not limiting. That is, when multiple data have different priorities (importances), data with a relatively high priority can be viewed as the first data, and data with a relatively low priority can be viewed as the second data. The first data can be smaller than the second data.

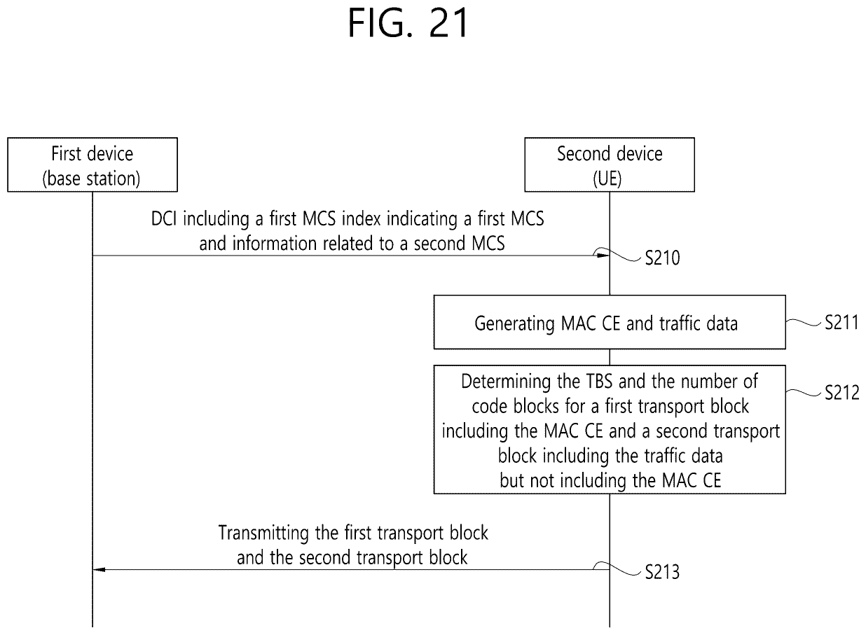

FIG. 21 illustrates signaling and operation between a first device and a second device in a wireless communication system.

Referring to FIG. 21, the first device may be, for example, a base station, and the second device may be a UE. The first device may provide the second device with a DCI including a first MCS index indicating a first MCS and information related to a second MCS (S210).

The second device generates MAC CE and traffic data (S211), and determines the TBS and the number of code blocks for a first transport block including the MAC CE and a second transport block including the traffic data but not including the MAC CE (S212). The specific method of determining the TBS and the number of code blocks for each transport block has been described in FIGS. 13 to 19.

The second device transmits the first transport block and the second transport block to the first device (S213).

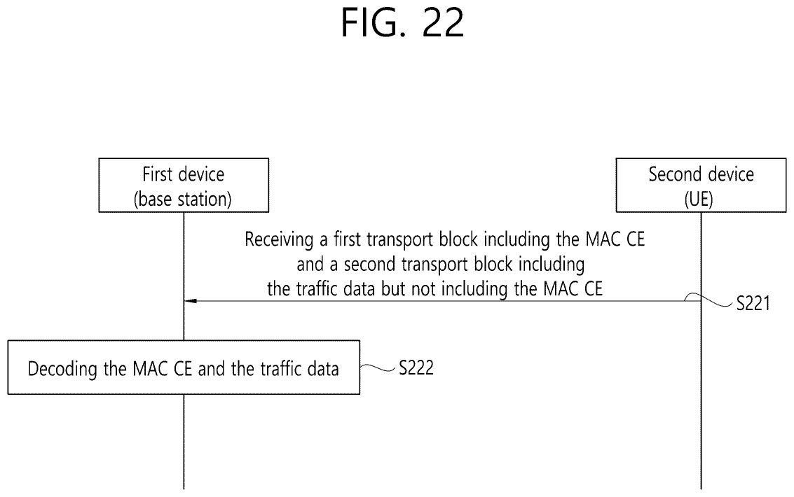

FIG. 22 illustrates an operation method of the first device (base station).

Referring to FIG. 22, the first device receives MAC CE and traffic data through a plurality of transport blocks (S221), and decodes the MAC CE and the traffic data (S222).

The plurality of transport blocks may include a first transport block including the MAC CE and a second transport block including the traffic data but not including the MAC CE. The first transport block always includes one code block (CB), and the second transport block includes one or a plurality of code blocks.

According to the present disclosure, when transmitting a MAC CE, the transmission reliability of the MAC CE can be increased while improving the efficiency of radio resource use by transmitting a first transport block including the MAC CE and a second transport block not including the MAC CE with different MCSs.

That is, when transmitting MAC CE (or a small amount of specific data that requires high transmission reliability) together with a large amount of data that requires relatively low transmission reliability, different MCSs can be applied to the two data groups for transmission. This allows for increasing the transmission reliability of MAC CE, thereby enhancing the stability and performance of the system, while at the same time maintaining the efficiency of resource usage when transmitting a large amount of data.

In addition, when notifying the different MCSs through DCI, the increase in the number of bits of DCI can be minimized.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method of transmitting a transport block (TB) of a user equipment (UE) in a wireless communication system, the method comprising:
generating first data and second data;
generating a plurality of MAC PDUs (protocol data units) including at least one of the first data and the second data, wherein the plurality of MAC PDUs include i) a first MAC PDU including the first data and having a first logical channel priority, and ii) a second MAC PDU not including the first data but including the second data and having a second logical channel priority lower than the first logical channel priority; and
transmitting the MAC PDUs through a plurality of transport blocks, wherein at most one MAC PDU is transmitted through one transport block,
wherein the plurality of transport blocks include a first transport block including the first MAC PDU and a second transport block including the second MAC PDU, and
wherein the first transport block always includes one code block (CB) and the second transport block includes one or a plurality of code blocks.

2. The method of claim 1, wherein a first modulation and coding scheme (MCS) is applied to the first transport block, and a second MCS is applied to the second transport block.

3. The method of claim 1, wherein the first data includes a media access control (MAC) control element (CE), and the second data includes traffic data.

4. The method of claim 2, wherein a first MCS index informing the first MCS is less than or equal to a second MCS index informing the second MCS.

5. The method of claim 2, further comprising:
receiving downlink control information (DCI).

6. The method of claim 5, wherein the DCI informs a first MCS index informing the first MCS and a second MCS index informing the second MCS.

7. The method of claim 6, wherein the DCI informs i) a value of the first MCS index and ii) a difference value between the value of the first MCS index and a value of the second MCS index.

8. The method of claim 1, wherein the DCI informs a number of total resource elements allocated to the UE and a number of transmission layers.

9. The method of claim 8, wherein a size of the first transport block, a size of the second transport block, and a number of code blocks included in the second transport block are calculated based on a first MCS index informing the first MCS, a second MCS index informing the second MCS, the number of the total resource elements, and the number of the transmission layers.

10. The method of claim 9, wherein a code rate and a modulation order of a transport block are obtained based on at least one of the first MCS index and the second MCS index.

11. The method of claim 9, wherein estimating a number of code blocks included in the first transport block and a minimum number of code blocks included in the second transport block, and
allocating the total resource elements to the first transport block and the second transport block based on the estimated number of code blocks included in the first transport block and the minimum number of code blocks included in the second transport block, and the first MCS and the second MCS, and
calculating the size of the first transport block, the size of the second transport block, and the number of code blocks included in the second transport block based on a number of resource elements allocated to each transport block and the number of the transmission layers.

12. A user equipment (UE) operated in a wireless communication system, the UE comprising:
a transceiver;
a processor connected to the transceiver; and
a memory operably coupled to the processor,
wherein the processor is adapted to:
generate first data and second data;
generate a plurality of MAC PDUs (protocol data units) including at least one of the first data and the second data, wherein the plurality of MAC PDUs include i) a first MAC PDU including the first data and having a first logical channel priority, and ii) a second MAC PDU not including the first data but including the second data and having a second logical channel priority lower than the first logical channel priority; and
transmit the MAC PDUs through a plurality of transport blocks, wherein at most one MAC PDU is transmitted through one transport block,
wherein the plurality of transport blocks include a first transport block including the first MAC PDU and a second transport block including the second MAC PDU, and
wherein the first transport block always includes one code block (CB) and the second transport block includes one or a plurality of code blocks.

13. The UE of claim 12, wherein a first modulation and coding scheme (MCS) is applied to the first transport block, and a second MCS is applied to the second transport block.

14. The UE of claim 13, wherein the first data includes a media access control (MAC) control element (CE), and the second data includes traffic data.

15. The UE of claim 13, wherein a first MCS index informing the first MCS is less than or equal to a second MCS index informing the second MCS.

16. The UE of claim 13, further comprising:
receiving downlink control information (DCI).

17. The UE of claim 16, wherein the DCI informs a first MCS index informing the first MCS and a second MCS index informing the second MCS.

18. The UE of claim 17, wherein the DCI informs i) a value of the first MCS index and ii) a difference value between the value of the first MCS index and a value of the second MCS index.

19. The UE of claim 12, wherein the DCI informs a number of total resource elements allocated to the UE and a number of transmission layers.

20-24. (canceled)

25. A method performed by a base station in a wireless communication system, the method comprising:
receiving first data and second data through a plurality of transport blocks; and
decoding the first data and the second data,
wherein the plurality of transport blocks include a first transport block including a first MAC PDU including the first data and having a first logical channel priority, and a second transport block including a second MAC PDU not including the first data but including the second data and having a second logical channel priority lower than the first logical channel priority, and
wherein the first transport block always includes one code block (CB), and the second transport block includes one or a plurality of code blocks.

26. (canceled)
